(19) United States
(12) Patent Application Publication
(10) Pub. No.: US 2009/0067882 A1
(43) Pub. Date: Mar. 12, 2009

(54) IMAGE FORMING APPARATUS, BEAM SCANNING APPARATUS THEREOF, AND METHOD OF BEAM SCANNING THEREOF

(75) Inventor: Yasushi KURIBAYASHI, Shizuoka-Ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/207,763

(22) Filed: Sep. 10, 2008

Related U.S. Application Data
(60) Provisional application No. 60/971,543, filed on Sep. 11, 2007.

(51) Int. Cl. G03G 15/04

(52) U.S. Cl. 399/220

(57) ABSTRACT

Provided is an image forming apparatus including: a photoconductor; a light including main exposure devices and redundant exposure devices; a beam scanning unit arranging main laser beam spots such that the they are separated by an image-forming unit distance, arranging redundant laser beam spots such that they are separated by the image-forming unit distance subsequently to the main laser beam spots, and simultaneously scan the main and redundant laser beam spots in the main scanning direction; and a device selection unit selecting exposure devices used in one-time scanning from the main and redundant exposure devices, wherein, when an image continuous in the sub scanning direction are exposed, the device selection unit selects the exposure devices such that the number of pairs of pixels which are adjacent and exposed by different scannings is equalized without depending on writing start positions of the image in the sub scanning direction.

### CROSS-REFERENCE TO RELATED APPLICATIONS

This application is based upon and claims the benefit of priority from: U.S. provisional application 60/971543, filed on Sep. 11, 2007, the entire contents of each of which are incorporated herein by reference.

### TECHNICAL FIELD

The present invention relates to an image forming apparatus, a beam scanning apparatus thereof, and a method of beam scanning thereof, and more particularly, an image forming apparatus for scanning multi-beams onto a photoconductor so as to perform exposure, a beam scanning apparatus thereof, and a method of beam scanning thereof.

### BACKGROUND

Conventionally, in an electrophotographic image forming apparatus, a method of scanning a laser beam output from a light emitting element such as a laser diode in a main scanning direction and a sub scanning direction and forming an electrostatic latent image on a photoconductor is widely used. The laser beam is scanned by an optical deflector, more specifically, by rotating a polygon mirror in the main scanning direction The laser beam is scanned by moving photoconductor in the sub scanning direction (perpendicular to the main scanning direction) and, more particularly, rotating a photoconductive drum.

Recently, in order to more rapidly form a high-resolution image, a technique of scanning multi-beam onto a photoconductor using a light emitting element for simultaneously outputting a plurality of laser beams is developed. In this technique (hereinafter, referred to as a multi-beam technique), a plurality of laser beam spots are arranged in the sub scanning direction separated from one another by an image-forming unit distance, and by scanning the plurality of laser beams one time in the main scanning direction, a plurality of lines can be formed simultaneously.

However, in the multi-beam technique, it is known that even when the intensities of the laser beams are identical, a difference in density appears in the formed image. Specifically, the difference in density appears in the following situations.

For example, when a stripe-like image, which has a two-dot width in the sub scanning direction and gradually inclined with respect to the main scanning direction as shown in FIG. 6, is exposed using with a multi-beam laser array having four light emitting elements, a density of the stripe-like image formed with a pair of (LD4 and LD1) is higher than those formed with other pairs of (LD1 and LD2), (LD2 and LD3) and (LD3 and LD4). Here, LD1, LD2, LD3, and LD4 are identification numbers assigned for each of the four light emitting elements. When the gradually inclined stripe-like image is formed periodically in the sub scanning direction, the difference in density becomes more distinguished.

The reason for the high density of the stripe-like image formed with a pair of (LD4 and LD1) is considered to be as follows.

The stripe-like image formed with other than the pair of (LD4 and LD1) is formed by a pair of laser beams which are reflected from the same surface of the polygon mirror.

In contrast, with regard to the stripe-like image formed with the pair of (LD4 and LD1), first, one-dot line is formed by a laser beam emitted from LD4 and reflected from one surface of the polygon mirror, then, another one-dot line is formed next to the previously formed line by a laser beam emitted from LD1 and reflected from the next surface of the polygon mirror. That is, the stripe-like image with the pair of (LD4 and LD1) is formed with two scans, and the time between the first scan and the second scan is such a time that the polygon mirror rotates with an angle for one surface.

When the photoconductor is exposed, it is considered that a probability that charges disappear by re-coupling of positive and negative charges generated by exposing the photoconductor, that is, a re-coupling probability, is higher in a region scanned by one-time scanning than that in a region scanned by two-time scanning (that is, charge density of one-time exposure is higher than that of two-time exposure) and, as a result, the charge amount for discharging a surface potential of the region scanned by two-time scanning is larger than that of the region scanned by one-time scanning (for example, see JP-A 2004-109680). This leads to a phenomenon which causes a difference in density between a one-time scanning region and a two-time scanning region.

The above mentioned phenomenon is called “reciprocity law failure”.

In order to decrease the influence of the reciprocity law failure, JP A 2003-205642 or JP A 2007-196460 discloses an image forming apparatus including a main exposure light source and a sub exposure light source for outputting multi-beam. These documents disclose a technique of forming a continuous-pixel image having a predetermined width by one-time scanning by using the sub exposure light source if two-time scanning should be performed when only the main exposure light source is used for forming the continuous-pixel image having the predetermined width (the width of the sub scanning direction).

JP-A 2003-205642 discloses a technique of arranging a beam head for the main exposure light source and a beam head for the sub exposure light source in parallel. However, in this case, the beam heads need to be aligned with high precision and thus there is a difficulty in assembling. In order to solve this problem, JP-A 2007-196460 discloses a technique of dividing one laser diode array into two groups, using one group as the main exposure light source and using the other group as the sub exposure light source.

However, in these techniques, if the width of the continuous-pixel image is larger than the predetermined width, it is difficult to suppress the occurrence of the reciprocity law failure. Even when an image having a band shape and a small width is formed and the image having the band shape is shifted in the sub scanning direction one pixel by one pixel so as to be gradually inclined, it is difficult to suppress the occurrence of the reciprocity law failure. Even in some cases, in order to avoid the reciprocity law failure, the number of laser diodes in the sub exposure light source should be increased up to the number of laser diodes in the main exposure light source and thus the use efficiency of the light source deteriorates.

### SUMMARY

The present invention is contrived to solve the above-mentioned problems, and an object of the present invention is to provide an image forming apparatus, which is capable of suppressing influence of reciprocity law failure without depending on the width or the shape of an image to be formed and without deteriorating the use efficiency of a light source, and a beam scanning apparatus thereof, and a method of beam scanning thereof.

According to an aspect of the present invention, there is provided an image forming apparatus including: a photoconductor; a light source configured to include a plurality of main exposure devices and a plurality of redundant exposure devices; a beam scanning unit configured to arrange a plurality of main laser beam spots output from the main exposure devices in a sub scanning direction of the photoconductor such that the main laser beam spots are separated from one another by an image-forming unit distance, arrange a plurality redundant laser beam spots output from the redundant exposure devices in the sub scanning direction of the photoconductor such that the redundant laser beam spots are separated from one another by the image-forming unit distance subsequently to the main laser beam spots, and simultaneously scan the main laser beam spots and the redundant laser beam spots in the main scanning direction of the photoconductor; and a device selection unit configured to select exposure devices used in one-time scanning of the main scanning direction from the plurality of main exposure devices and the plurality of redundant exposure devices, wherein, when an image which are continuous in the sub scanning direction are exposed, the device selection unit selects the exposure devices such that the number of pairs of pixels which are adjacent and are exposed by different scannings is equalized in the sub scanning direction of the images without depending on writing start positions of the images in the sub scanning direction.

According to another aspect of the present invention, there is provided a beam scanning apparatus including: a light source configured to include a plurality of main exposure devices and a plurality of redundant exposure devices; a beam scanning unit configured to arrange a plurality of main laser beam spots output from the main exposure devices in a sub scanning direction of the photoconductor such that the main laser beams are separated from one another by an image-forming unit distance, arrange a plurality redundant laser beam spots output from the redundant exposure devices in the sub scanning direction of the photoconductor such that the redundant laser beam spots are separated from one another by the image-forming unit distance subsequently to the main laser beam spots, and simultaneously scan the main laser beam spots and the redundant laser beam spots in the main scanning direction of the photoconductor; and a device selection unit configured to select exposure devices used in one-time scanning of the main scanning direction from the plurality of main exposure devices and the plurality of redundant exposure devices, wherein, when an image which are continuous in the sub scanning direction are exposed, the device selection unit selects the exposure devices such that the number of pairs of pixels which are adjacent and are exposed by different scannings is equalized in the sub scanning direction of the images without depending on writing start positions of the images in the sub scanning direction.

According to another aspect of the present invention, there is provided a beam scanning method including: arranging a plurality of main laser beam spots output from a plurality of main exposure devices in a sub scanning direction of a photoconductor such that the main laser beam spots are separated from one another by an image-forming unit distance; arranging a plurality of redundant laser beam spots output from a plurality of redundant exposure devices in the sub scanning direction of the photoconductor subsequently to the arrangement of the main laser beam spots such that the redundant laser beam spots are separated from one another by an image-forming unit distance; simultaneously scanning the main laser beam spots and the redundant laser beam spots in a main scanning direction of the photoconductor; and selecting exposure devices used in one-time scanning of the main scanning direction from the plurality of main exposure devices and the plurality of redundant exposure devices, wherein, when an image which are continuous in the sub scanning direction are exposed, the selecting includes selecting the exposure devices such that the number of pairs of pixels which are adjacent and are exposed by different scannings is equalized in the sub scanning direction of the images without depending on writing start positions of the images in the sub scanning direction.

### DESCRIPTION OF THE DRAWINGS

FIG. 1 is a perspective view showing the appearance of an image forming apparatus according to an embodiment of the present invention.

FIG. 2 is a view showing the configuration of the image forming apparatus according to the embodiment of the present invention.

FIG. 3 is a view showing the configuration of a beam scanning apparatus according to an embodiment of the present invention.

FIGS. 4A and 4B are conceptual views of multi-beam scanning of a plurality of exposure devices.

FIG. 5 is a view of multi-beam scanning of a conventional example.

FIG. 6 is a view showing an occurrence mechanism of reciprocity law failure.

FIG. 7 is a view showing the problem of the reciprocity law failure due to conventional beam scanning.

FIG. 8 is a view showing an example of arrangement of exposure devices and beam scanning according to the present embodiment.

FIG. 9 is a view showing an example of arrangement of exposure devices and beam scanning when the number of main exposure devices is 4 and the number of redundant exposure devices is 2.

FIGS. 10A and 10B are views showing a beam scanning method (a dot width in a sub scanning direction is 2) according to a first embodiment.

FIGS. 11A and 11B are views showing the beam scanning method (a dot width in a sub scanning direction is 3) according to the first embodiment.

FIGS. 12A and 12B are views showing the beam scanning method (a dot width in a sub scanning direction is 4) according to the first embodiment.

FIGS. 13A and 13B are views showing the beam scanning method (a dot width in a sub scanning direction is 5) according to the first embodiment.

FIGS. 14A and 14B are views showing the beam scanning method (a dot width in a sub scanning direction is 6) according to the first embodiment.

FIGS. 15A and 15B are views showing the beam scanning method (a dot width in a sub scanning direction is 7) according to the first embodiment.

FIGS. 16A and 16B are views showing the beam scanning method (a dot width in a sub scanning direction is 8) according to the first embodiment.

FIGS. 17A to 17C are Views for obtaining the number m (n=4) or redundant exposure devices necessary for uniformization by a combination of decrease and increase of the occurrence number of reciprocity law failure.

FIGS. 18A and 18B are views for obtaining the number m (n=2) of redundant exposure devices necessary for uniformization by a combination of decrease and increase of the occurrence number of reciprocity law failure.

FIGS. 19A and 19B are views for obtaining the number m (n=3) of redundant exposure devices necessary for uniformization by a combination of decrease and increase of the occurrence number of reciprocity law failure.

FIGS. 20A and 20B are views for obtaining the number m (n=5) of redundant exposure devices necessary for uniformization by a combination of decrease and increase of the occurrence number of reciprocity law failure.

FIGS. 21A and 21B are views for obtaining the number m (n=6) of redundant exposure devices necessary for uniformization by a combination of decrease and increase of the occurrence number of reciprocity law failure.

FIGS. 22A and 22B are views for obtaining the number m (n=7) of redundant exposure devices necessary for uniformization by a combination of decrease and increase of the occurrence number of reciprocity law failure.

FIG. 23 is a view for generally obtaining a relationship between the number m of redundant exposure devices and the number n of main exposure devices necessary for uniformization by a combination of decrease and increase of the occurrence number of reciprocity law failure.

FIGS. 24A to 24E are views showing the number m of redundant exposure devices and the beam scanning method when the number n of the main exposure devices is 2 to 6.

FIGS. 25A and 25B are views for obtaining the number m (n=4) of redundant exposure devices necessary for uniformizing the occurrence number of reciprocity law failure when the number of main exposure devices is a multiple of 4 and the dot width in the sub scanning direction is an even number.

FIGS. 26A and 26B are views for obtaining the number m (n=8) of redundant exposure devices necessary for uniformizing the occurrence number of reciprocity law failure when the number of main exposure devices is a multiple of 4 and the dot width in the sub scanning direction is an even number.

FIGS. 27A and 27B are views for obtaining the number m (n=12) of redundant exposure devices necessary for uniformizing the occurrence number of reciprocity law failure when the number of main exposure devices is a multiple of 4 and the dot width in the sub scanning direction is an even number.

FIG. 28 is a view for generally obtaining a relationship between the number m of redundant exposure devices and the number n of main exposure devices necessary for uniformizing the occurrence number of reciprocity law failure when the number of main exposure devices is a multiple of 4 and the dot width in the sub scanning direction is an even number.

FIGS. 29A and 29B are views for obtaining the number m (n=4) of redundant exposure devices necessary for uniformization without increasing or decreasing the occurrence number of reciprocity law failure.

FIGS. 30A and 30B are views for obtaining the number m (n=5) of redundant exposure devices necessary for uniformization without increasing or decreasing the occurrence number of is reciprocity law failure.

FIGS. 31A and 31B are views for obtaining the number m (n=6) of redundant exposure devices necessary for uniformization without increasing or decreasing the occurrence number of reciprocity law failure.

FIGS. 32A and 32B are views for obtaining the number m (n=7) of redundant exposure devices necessary for uniformization without increasing or decreasing the occurrence number of reciprocity law failure.

FIG. 33 is a view for generally obtaining a relationship between the number m of redundant exposure devices and the number n of main exposure devices necessary for uniformization without increasing or decreasing the occurrence number of reciprocity law failure.

FIGS. 34A and 34B are first views illustrating reciprocity law failure which occurs in a main scanning direction.

FIGS. 35A and 35B are second views illustrating reciprocity law failure which occurs in a main scanning direction.

FIG. 36 is a view showing an example of a halftone pattern.

FIGS. 37A to 37D are views showing the problem of reciprocity law failure which occurs when a halftone pattern is exposed by a conventional multi-beam scanning method.

FIGS. 38A to 38D are first views showing the uniformization of the occurrence of reciprocity law failure in a halftone pattern by a beam scanning method according to a third embodiment.

FIGS. 39A to 39D are second views showing the uniformization of the occurrence of reciprocity law failure in a halftone pattern by the beam scanning method according to the third embodiment.

### DETAILED DESCRIPTION

An image forming apparatus, a beam scanning apparatus thereof, and a method of beam scanning thereof according to embodiments of the present invention will be described with reference to the accompanying drawings.

### (1) Configuration

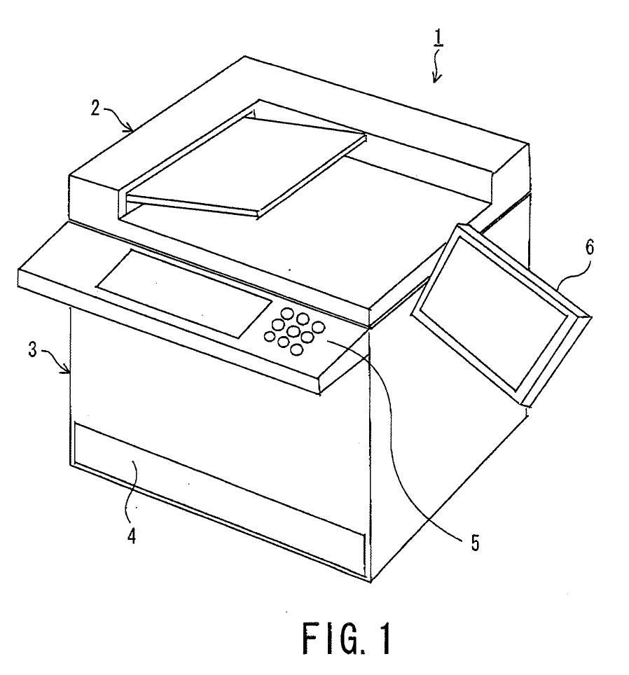

FIG. 1 is a view showing the appearance of a copier (or a MFP (Multifunction Peripheral)) according to an example of an image forming apparatus 1 according to the present embodiment.

The image forming apparatus 1 includes a read unit 2, an image forming unit 3, a paper feed unit 4 and the like. The read unit 2 optically reads an original laid on a platen or an original input to an auto document feeder (ADF) and generates image data.

The image forming unit 3 prints the image data on a sheet fed from the paper feed unit 4 using an electrophotographic method. In the image forming unit 3, a control panel 5 for allowing a user to perform various types of manipulations or a display panel 6 for displaying a variety of information.

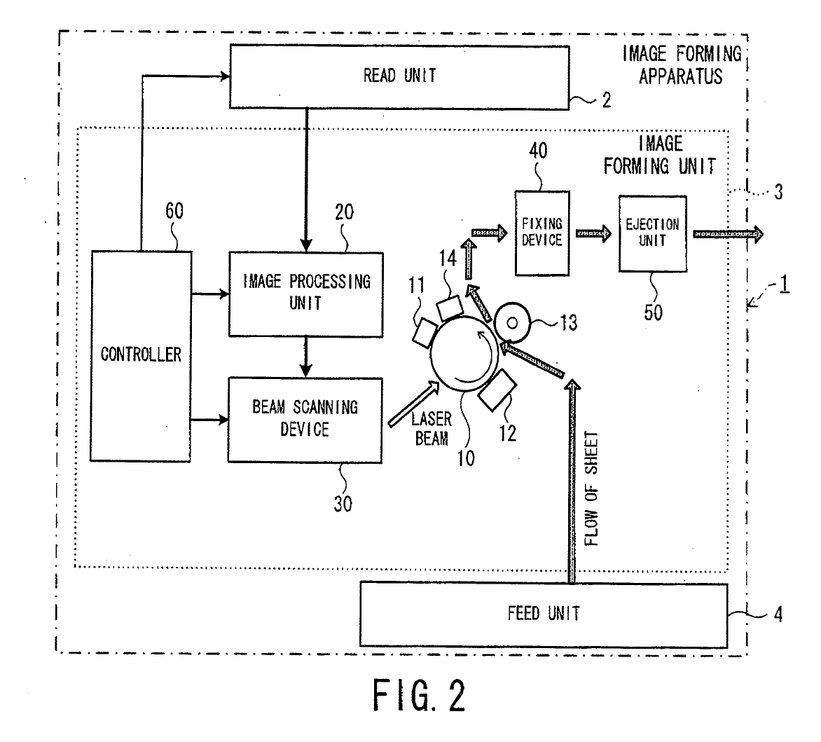

FIG. 2 is a cross-sectional view showing the internal configuration of the image forming unit 3. The image forming unit 3 includes a photoconductive drum 10. In the periphery of the photoconductive drum 10, a charge device 11, a development device 12, a transfer roller 13, a cleaner 14 and the like are sequentially arranged from an upstream side to a downstream side of rotation.

The surface of the photoconductive drum 10 is uniformly charged with a predetermined potential by the charge device 11. Thereafter, a laser beam which is pulse-width modulated according to the level of the image data is irradiated onto the surface of the photoconductive drum 10.

The image data from the original by the read unit 2 is subjected to a predetermined image process by an image processing unit 20 and is then input to a beam scanning apparatus 30. In the beam scanning apparatus 30, the laser beam which is pulse-width modulated according to the level of the image data is generated and the generated laser beam is scanned in a rotation axis direction of the photoconductive drum 10, that is, the main scanning direction. In the beam scanning apparatus 30 according to the present embodiment, a plurality of laser beams are simultaneously generated and irradiated so as to be adjacent in a sub scanning direction (a direction perpendicular to a main scanning direction) of the photoconductive drum. The detailed configuration of the beam scanning apparatus 30 or a beam scanning method will be described later.

When the laser beams are irradiated onto the surface of the photoconductive drum 10, the potential of the portion onto which the laser beams are irradiated is decreased and an electrostatic latent image is formed on the surface of the photoconductive drum 10.

The development device 12 develops the electrostatic latent image of the photoconductive drum 10 by a toner. By this development, a toner image is formed on the surface of the photoconductive drum 10.

The sheet is picked up by the paper feed unit 4 and is transported to a position (transfer position) where the photoconductive drum 10 and the transfer roller 13 face each other. The toner image of the photoconductive drum 10 is transferred onto the sheet transported to the transfer position. The toner image transferred onto the sheet is heated and pressurized by a fixing device 40 and is fixed on the sheet. Thereafter, the sheet is ejected to the outside of the image forming apparatus 1 by an ejection unit 50.

The photoconductive drum 10 which completes the transfer onto the sheet waits for printing of a next sheet by removing the toner remaining on the surface thereof by the cleaner 14. By repeating the above-described process, continuous printing can be performed.

A control unit 60 controls components such as the read unit 2, the image processing unit 20 and the beam scanning apparatus 30 or the whole operation of the image forming apparatus 1.

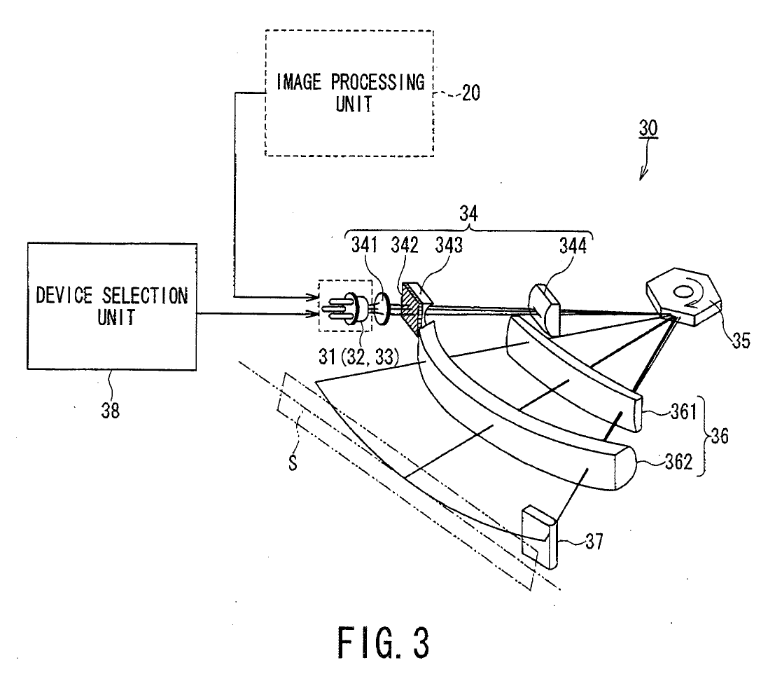

FIG. 3 is a view showing the configuration of the beam scanning apparatus 30 according to the present embodiment. The beam scanning apparatus 30 includes a light source 31 for outputting a laser beam, a pre-deflection optical system 34, an optical deflector 35, and a post-deflection optical system 36.

The light source 31 according to the present embodiment outputs a plurality of laser beams (multi-beam type) and includes a plurality of main exposure devices 32 and one or a plurality of redundant exposure devices 33 as described later. Each of the exposure devices (the main exposure devices 32 or the redundant exposure devices 33) outputs one laser beam.

The pre-deflection optical system 34 includes a collimate lens 341 for converting the laser beams output from the light source 31 to parallel lights, an aperture 342 for shaping the lights to predetermined beam cross-sectional shape, and cylindrical lenses 343 and 344 for focusing the lights in the sub scanning direction.

The optical deflector 35, a polygon mirror as a typical example, has a plurality of reflection surfaces and rotates at a predetermined rotation speed in a direction denoted by an arrow by a motor (not shown) so as to scan the laser beams in the main scanning direction.

The post-deflection optical system 36 includes focusing lenses (fθ lenses, etc.) 361 and 362 for focusing the laser beams deflected by the optical deflector 35 on the surface S of the photoconductive drum 10 in a linear shape with the same beam diameter.

A beam detector 37 is provided on the upstream side of the main scanning direction and a horizontal synchronization signal is obtained from the beam detector 37.

The beam scanning apparatus 30 according to the present embodiment includes a device selection unit 38. The device selection unit 38 selects an exposure device to be used from the plurality of main exposure devices 32 and the redundant exposure devices 33. A detailed selection method will be described later.

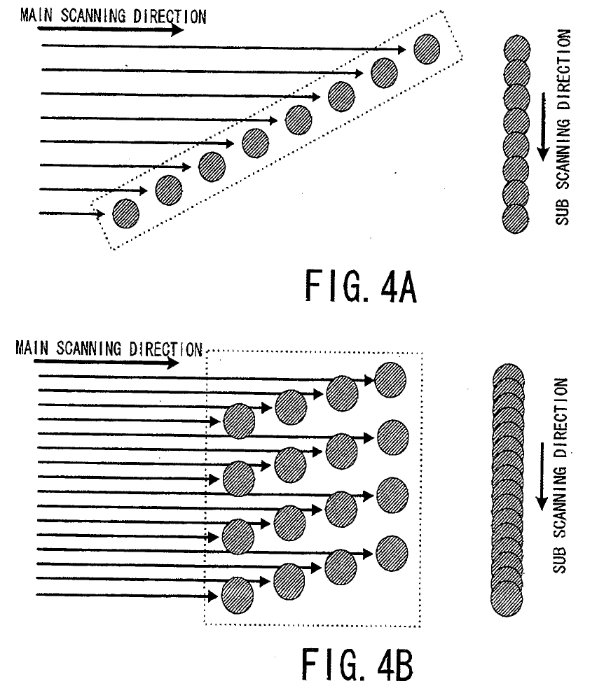

FIGS. 4A and 4B are views conceptually showing the arrangement of the plurality of exposure devices configuring the light source 31. In the example shown in FIG. 4A, the light source 31 in which eight exposure devices are arranged in a linear shape is shown. From the restriction of the size of the exposure devices, a distance between the exposure devices multiplied by an optical magnification is not usually identical with, but in many cases exceeds an image-forming unit distance. Therefore, the exposure devices are obliquely arranged so that a separation of the beam spots on the photoconductive drum 10 in the sub scanning direction can be an image-forming unit distance. Here, an image-forming unit distance is a distance such as about 42.3 μm for 600 dpi, or about 21.2 μm for 1200 dpi, for example.

As shown in FIG. 4A, since the exposure devices are arranged with a predetermined separation from each other in the main scanning direction, emitting timing for each exposure device is adjusted to form a vertical line in the sub scanning direction.

In the example shown in FIG. 4B, the light source 31 in which 16 exposure devices are arranged in a surface shape (4×4) is shown.

In FIGS. 4A and 4B, the main exposure devices 32 and the redundant exposure devices 33 are shown without distinguishing them.

### (2) Beam Scanning Method (First Embodiment)

Hereinafter, the image forming apparatus 1 and the beam scanning method (first embodiment) of the beam scanning apparatus 30 will be described. Before the beam scanning method according to the first embodiment is described, the influence of the reciprocity law failure in a conventional beam scanning method using the multi-beam will be briefly described.

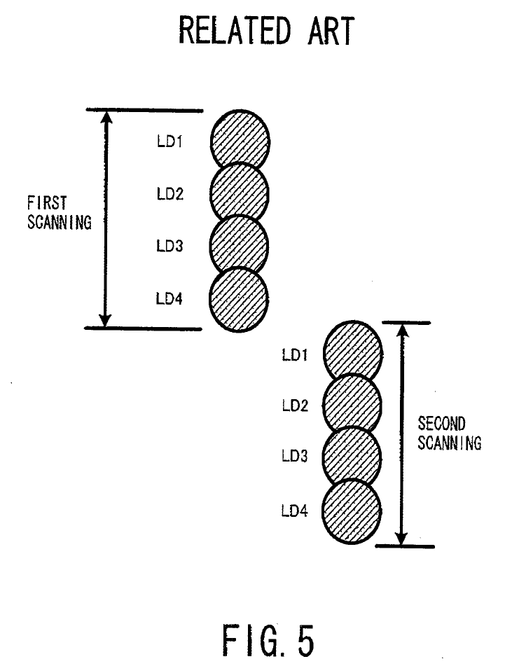

FIG. 5 shows a light source having four exposure devices LD1 to LD4 as an example of a conventional light source. This light source can expose an image having a width of four dots onto the photoconductive drum 10 in the sub scanning direction by one-time scanning (scanning of the main scanning direction). If one-time scanning is completed, the exposure devices are shifted by four dots in the sub scanning direction by the rotation of the photoconductive drum 10 and a next image region is exposed by the width of four dots.

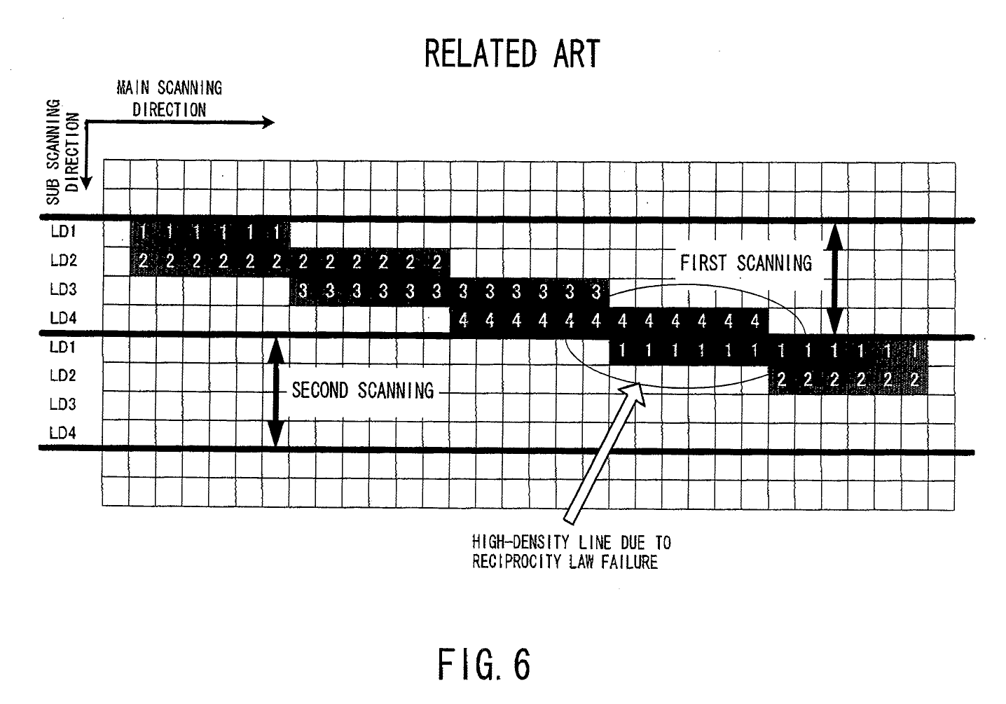

FIG. 6 shows an example of exposing a linear image which is gradually inclined with respect to the main scanning direction and has a width of 2 dots in the sub scanning direction, using the conventional light source (four exposure devices). Hereinafter, this image is called an oblique linear image having an N-dot width (N is an integer of 2 or more).

If the oblique linear image having the 2-dot width shown in FIG. 6 is exposed using the four exposure devices LD1 to LD4, in the vicinity of the left end of the oblique linear image, two exposure devices LD1 and LD2 are turned on and the exposure devices LD3 and LD4 are turned off (the image of a first stage from the left side). Next, the two exposure devices LD2 and LD3 are turned on and the exposure devices LD1 and LD4 are turned off (the image of a second stage from the left side). Next, the two exposure devices LD3 and LD4 are turned on and the exposure devices LD1 and LD2 are turned off (the image of a third stage from the left side). The exposure devices corresponding to a writing start position of the sub scanning direction of the linear image are sequentially shifted such that the oblique linear image is sequentially exposed. The images of the first stage to the third stage from the left side can be exposed by one-time scanning.

However, in order to continuously expose the oblique linear image, two-time (or more) scanning is required instead of one-time scanning. In more detail, if the image of a fourth stage from the left side is exposed, the exposure device LD4 is turned on (LD1, LD2 and LD3 are turned off) in first scanning and the exposure device LD1 is turned on (LD2, LD3 and LD4 are turned off) in second scanning. Since the image of the fourth stage is exposed by two different scanning, the image of the fourth stage is influenced by the reciprocity law failure and is exposed with a high density, compared with the images of the first to third stages from the left side.

Subsequently, if the image of a fifth stage from the left side is exposed, the two exposure devices LD1 and LD2 are turned on and the exposure devices LD3 and LD4 are turned off such that the image of the fifth stage is exposed by one-time scanning (second scanning) and thus is not influenced by the reciprocity law failure.

If the oblique linear image having the 2-dot width is formed, a high-density region which is influenced by the reciprocity law failure occurs in a portion of the linear image. Accordingly, density unevenness occurs in the formed image so as to deteriorate image quality.

As described above, JP-A 2003-205642 or JP-A 2007-196460 discloses a technique of dividing one laser diode array into two groups, using one group as the main exposure device, and using the other group as the sub exposure device (substantially corresponding to the redundant exposure device of the present embodiment), in order to suppress the influence of the reciprocity law failure.

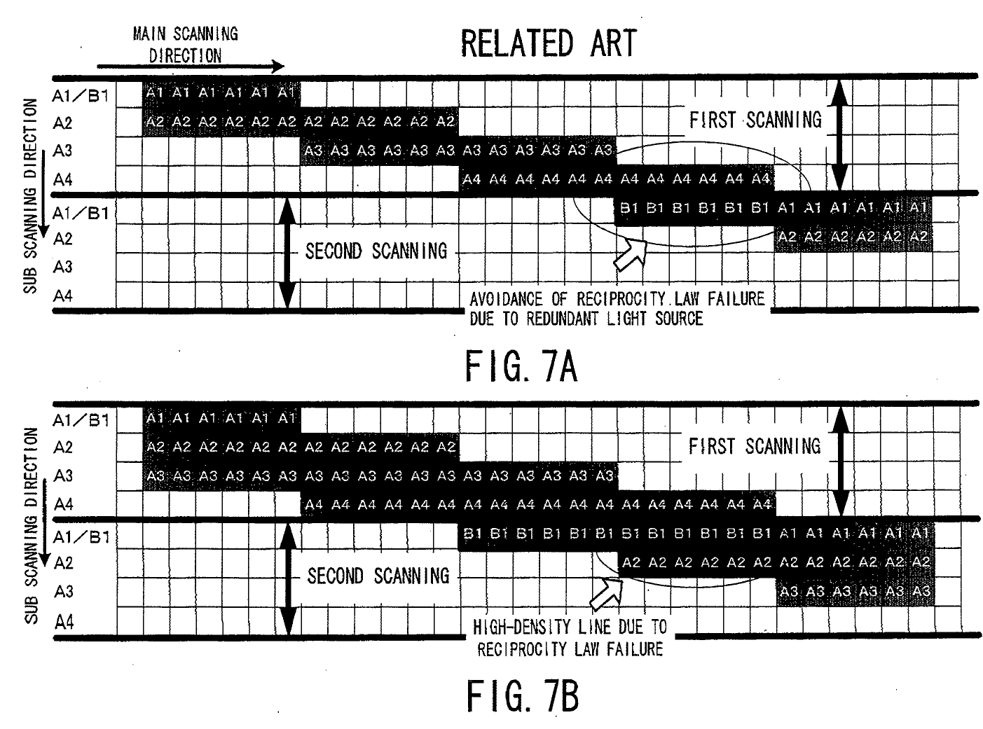

FIGS. 7A and 7B are views showing the technique and the problem disclosed in the above-described documents. FIGS. 7A and 7B show an example of using four main exposure devices A1 to A4 and one sub exposure device B1.

Similarly to FIG. 6, FIG. 7A shows an example of exposing an oblique linear image having a 2-dot width. In this case, if the main exposure device A4 and the sub exposure device B1 are used when an image of a fourth stage from the left side is exposed, the exposure can be performed by one-time scanning instead of two-time scanning. Thus, the influence of the reciprocity law failure shown in FIG. 6 can be eliminated.

However, if the width of the oblique linear image is increased, for example, becomes a 3-dot width as shown in FIG. 7B and only the sub exposure device B1 is used when the image of the fourth stage from the left side is exposed, the exposure cannot be performed by one-time scanning. Thus, the two-time scanning should be performed and thus the influence of the reciprocity law failure occurs. In order to eliminate the influence of the reciprocity law failure of this region, the number of sub exposure devices need to be increased.

An object of the technique disclosed in JP-A 2003-205642 or JP-A 2007-196460 is to prevent the reciprocity law failure from occurring by using the sub exposure device (to set the occurrence of the reciprocity law failure to zero). However, if an image having a large width, which is continuous in the sub scanning direction, is exposed, it is difficult to completely set the occurrence of the reciprocity law failure to zero. Thus, the high-density region which is influenced by the reciprocity law failure is generated.

In contrast, in the image forming apparatus 1 or the beam scanning method of the beam scanning apparatus 30 according to the embodiments of the present invention, the occurrence of the reciprocity law failure is not set to zero. That is, a method of uniformly distributing regions where the reciprocity law failure occurs (that is, the high-density regions) in the entire image when the reciprocity law failure occurs is employed. As a result, the high-density regions which occur due to the reciprocity law failure are uniformly distributed in the entire image without concentrating at a specific place and thus an image having good image quality can be formed with the uniform density.

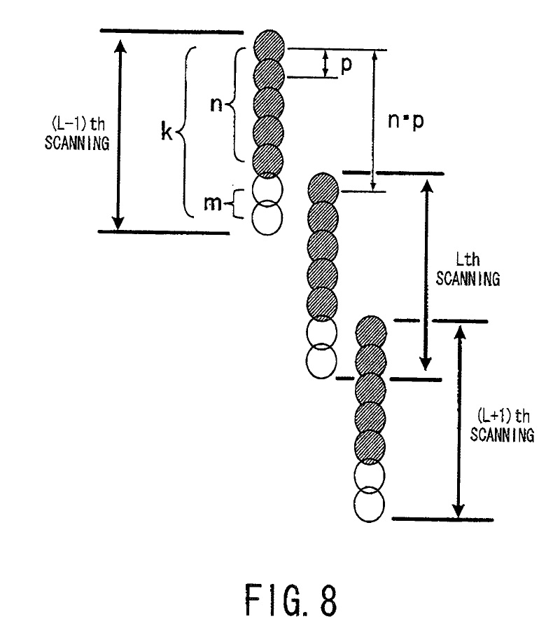

FIG. 8 is a view showing the arrangement of the exposure devices and the scanning method, for realizing the beam scanning method according to the embodiments of the present invention. The light source 31 according to the present embodiment includes a total of k exposure devices including n main exposure devices 32 and m redundant exposure devices 33. The laser beams (main laser beams) output from the main exposure devices 32 are arranged in a line with a distance p in the sub scanning direction of the photoconductive drum 10. In FIG. 8, the main laser beams are shown by hatched circles. The laser beams (redundant laser beams) output from the redundant exposure devices 33 are also arranged in a line with a distance p in the sub scanning direction of the photoconductive drum 10 next to the arrangement of the main laser beams. In FIG. 8, the redundant laser beams are shown by white non-hatched circles.

The n main laser beams and the m redundant laser beams can be simultaneously scanned in the main scanning direction by one-time scanning. At this time, the laser beams are scanned such that the positions of the m redundant laser beams in a certain scanning (for example, (L−1)th scanning) and the positions of m leading laser beams of the n main laser beams in the next scanning (Lth scanning) overlap with each other in the sub scanning direction. This implies that between the (L−1)th scanning and the Lth scanning, the photoconductive drum 10 rotates so as to move in the sub scanning direction with a distance of n·p.

In the overlap portion, the main exposure devices 32 and the redundant exposure devices 33 are selected by the device selection unit 38 such that any one of the redundant laser beams and the main laser beams is selected.

The redundant exposure devices 33 are used for exposing the image, which should be exposed by two-time scanning when the redundant exposure devices 33 are not included, by one-time scanning. This indicates that the redundant exposure devices 33 are selected and used in order to decreasing the occurrence of the reciprocity law failure. In this case, when the redundant exposure devices 33 are selected in any scanning, the main exposure devices 32 positioned at the same beam positions in the next scanning are not selected.

In contrast, if the image can be exposed by one-time scanning when the redundant exposure devices 33 are selected in any scanning, the redundant exposure devices 33 are not intentionally selected and the image positioned at the beam position can be exposed by the main exposure devices 32 in the next scanning. This indicates that the main exposure devices 32 and the redundant exposure devices 33 are selected and used in order to intentionally increase the occurrence of the reciprocity law failure.

In the beam scanning method according to the first embodiment, the redundant exposure devices 33 are used for decreasing or increasing the occurrence of the reciprocity law failure. As a result, as described below, the number of redundant exposure devices 33 can be minimized.

Hereinafter, the concrete beam scanning method according to the first embodiment when the number n of main exposure devices 32 is 4 and the number m of redundant exposure devices is 2 (the total number k of exposure devices is 6) will be described in detail.

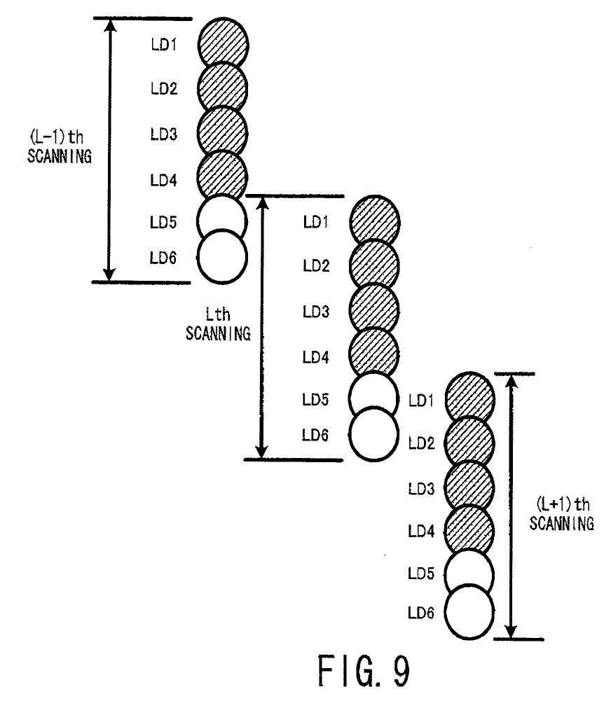

FIG. 9 shows the positions of the main laser beams and the redundant laser beams in (L−1)th scanning, Lth scanning and (L+1)th scanning when the number n of main exposure devices 32 is 4 (LD1 to LD4) and the number m of redundant exposure devices is 2 (LD5 and LD6). Any one of the redundant exposure device LD5 in any scanning (for example, (L−1)th scanning) and the main exposure device LD1 in next scanning (Lth scanning) is selected. Similarly, any one of the redundant exposure device LD6 in any scanning (for example, (L−1)th scanning) and the main exposure device LD2 in next scanning (Lth scanning) is selected.

Also for this case, between the (L−1)th scanning and the Lth scanning, or between the Lth scanning and the (L+1)th scanning, the photoconductive drum 10 rotates so as to move in the sub scanning direction with a distance of n·p.

The occurrence of the reciprocity law failure when the redundant exposure devices are not used varies according to a relative relationship between the writing start position of a target image (the exposure start position of the image in the sub scanning direction) and the exposure device and the size of the target image and more particularly the width of the target image in the sub scanning direction.

For example, if writing is started from the exposure device LD1 in the sub scanning direction when the horizontal linear image having the 2-dot width is exposed in the main scanning direction (that is, if the writing start position of the image is LD1), this linear image is exposed using the exposure devices LD1 and LD2 by one-time scanning and thus the reciprocity law failure does not occur in the entire region of the main scanning direction. If the writing start position of the image is LD4, a one-dot line of this linear image is exposed using the exposure device LD4 by first scanning and one-dot line thereof is exposed using the exposure device LD1 by next scanning. That is, the linear image having the 2-dot width is exposed by two-time scanning such that the reciprocity law failure occurs in the entire region of the main scanning direction so as to form the high-density region. Accordingly, the occurrence of the reciprocity law failure varies depending on from which of main scanning devices the writing of the target image is started.

Even when the writing start position of the image is LD1, the occurrence of the reciprocity law failure varies according to the width of the target image in the sub scanning direction. If the writing start position of the image is LD1, the reciprocity law failure does not occur when the dot width N of the image is 2 to 4. However, when the dot width N is 5 to 8, two-time scanning is required and thus the reciprocity law failure occurs at one place in the sub scanning direction. When the dot width N is 9 to 12, three-time scanning is required and thus the reciprocity law failure occurs at two places in the sub scanning direction.

The occurrence of the reciprocity law failure varies according to the writing start position of the image and the width of the image. Hereinafter, how the beam scanning method according to the present embodiment increases or decreases the occurrence of the reciprocity law failure and the influence of the reciprocity law failure is equalized thereby with respect to different writing start positions and dot widths will be described.

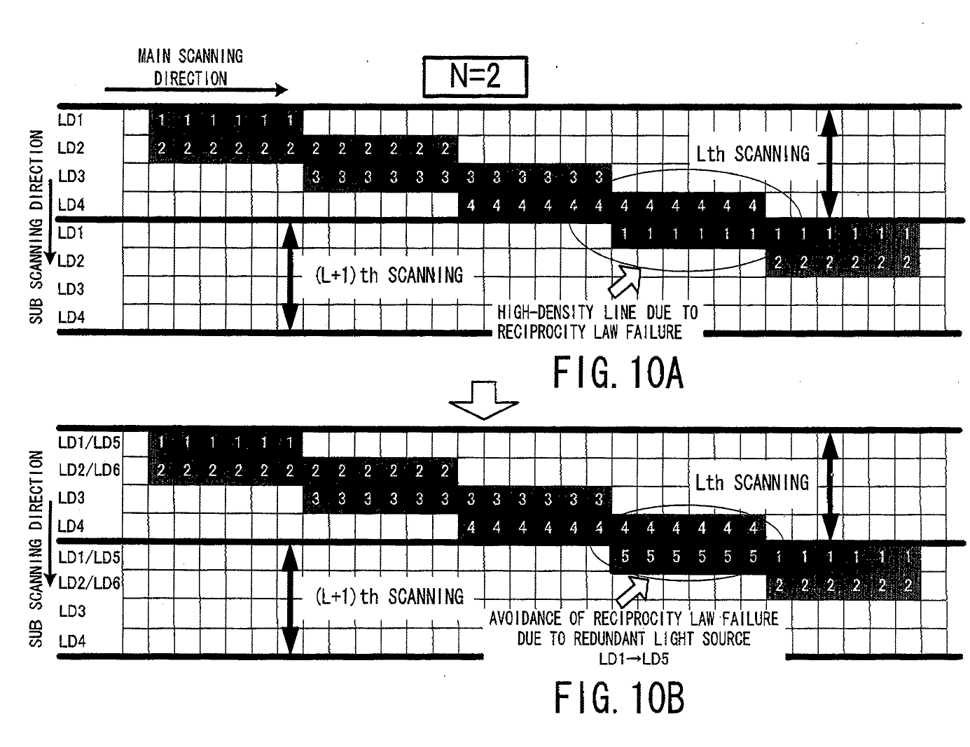

FIGS. 10A and 10B to FIGS. 16A to 16B are views corresponding to the dot widths N=2 to 8 of the image of the sub scanning direction. Among them, FIGS. 10A to 16A are views when the number n of main exposure devices is 4 and the number m of redundant exposure devices is 0 (that is, the redundant exposure device is not used). FIGS. 10B to 16B are views when the number n of main scanning devices is 4 and the number m of redundant exposure devices is 2.

FIG. 10A is a view showing how the reciprocity law failure occurs in the conventional beam scanning method without the redundant exposure device if the dot width is N=2. An image to be checked is an oblique linear image having the dot width N=2 and the images of the first, second, third and fourth stages from the left side are positioned at different writing start positions LD1, LD2, LD3 and LD4. When the writing start position is LD4, the reciprocity law failure occurs.

FIG. 10B is a view showing the beam scanning method according to the present embodiment (having the redundant exposure devices LD5 and LD6) if the dot width is N=2. When the writing start position is LD4, the exposure of one-time scanning is possible by using the redundant exposure device LD5. As a result, the reciprocity law failure does not occur at all the writing start positions LD1 to LD4 and thus the influence of the reciprocity law failure is equalized regardless of the writing start position.

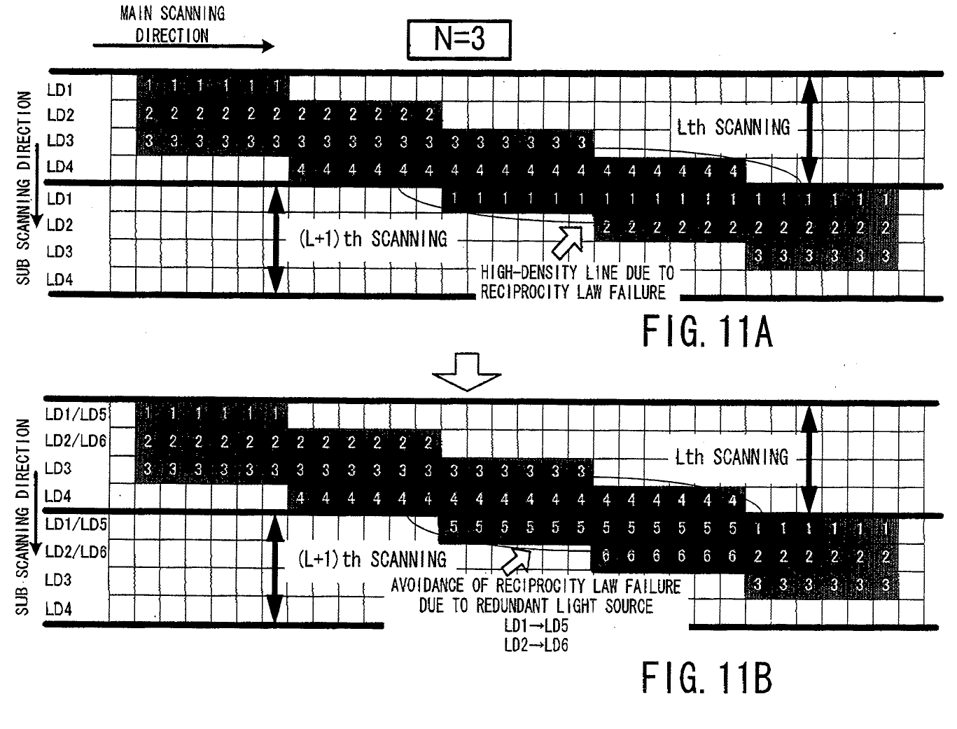

FIG. 11A is a view showing how the reciprocity law failure occurs in the conventional beam scanning method without the redundant exposure device if the dot width is N=3. When the writing start position is LD3 and LD4, the reciprocity law failure occurs.

In contrast, in the present embodiment (FIG. 11B), when the writing start position is LD3, the exposure of one-time scanning is possible by using the redundant exposure device LD1 instead of the redundant exposure device LD5. Similarly, when the writing start position is LD4, the exposure of one-time scanning is possible by using the redundant exposure devices LD5 and LD6 instead of the redundant exposure devices LD1 and LD2, respectively. As a result, the reciprocity law failure does not occur at all the writing start positions LD1 to LD4 and thus the influence of the reciprocity law failure is equalized regardless of the writing start position.

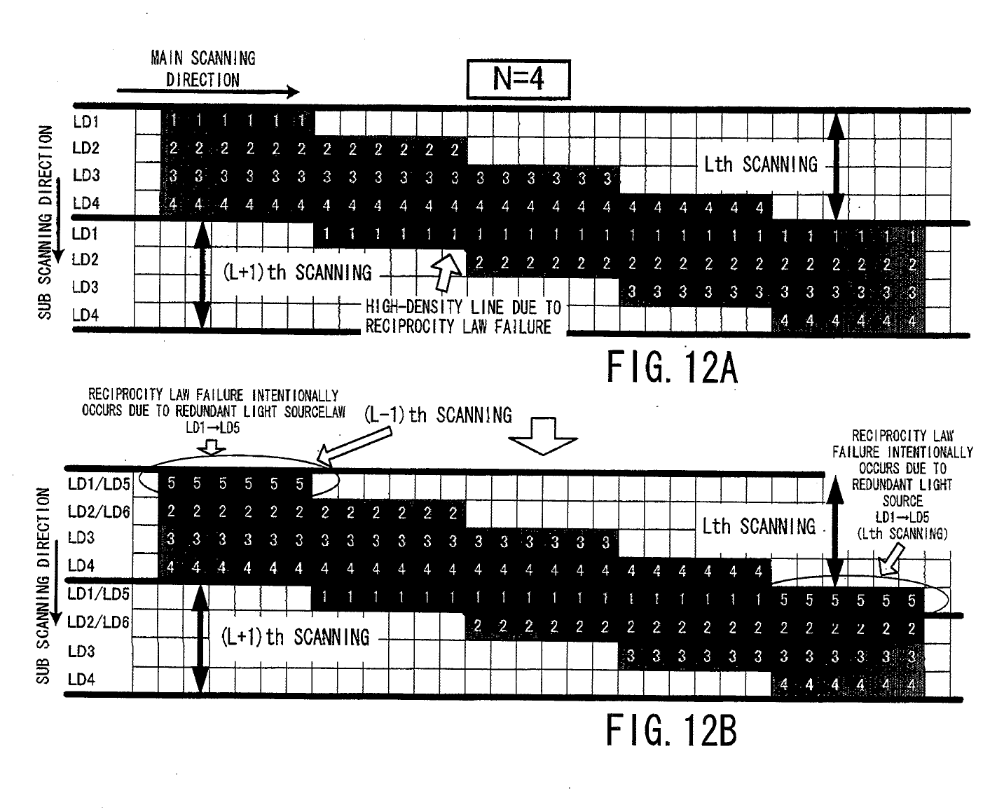

FIG. 12A is a view showing how the reciprocity law failure occurs in the conventional beam scanning method without the redundant exposure device if the dot width is N=4. When the writing start position is LD2, LD3 and LD4, the reciprocity law failure occurs.

When the writing start position is LD4 (the fourth stage from the left side) and the image having the dot width N=4 is desired to be exposed by one-time scanning, the redundant exposure devices LD5 and LD6 are used instead of LD1 and LD2 and, moreover, a new redundant exposure device LD7 which will be used instead of LD3 is necessary.

As described above, the equalization of the occurrence of the reciprocity law failure is realized by decreasing or increasing the occurrence of the reciprocity law failure. In the beam scanning method according to the first embodiment, the number of necessary redundant exposure devices can be minimized by a combination of the increase and the decrease of the occurrence of the reciprocity law failure.

When the dot width is N=4, the equalization is realized by increasing the occurrence of the reciprocity law failure regardless of the writing start position, which is shown in FIG. 12B.

In the image region of the first stage from the left side of FIG. 12B, the reciprocity law failure intentionally occurs by using LD5 in just before scanning instead of LD1 and the occurrence number of reciprocity law failures is equalized to 1 regardless of the writing start position of the image.

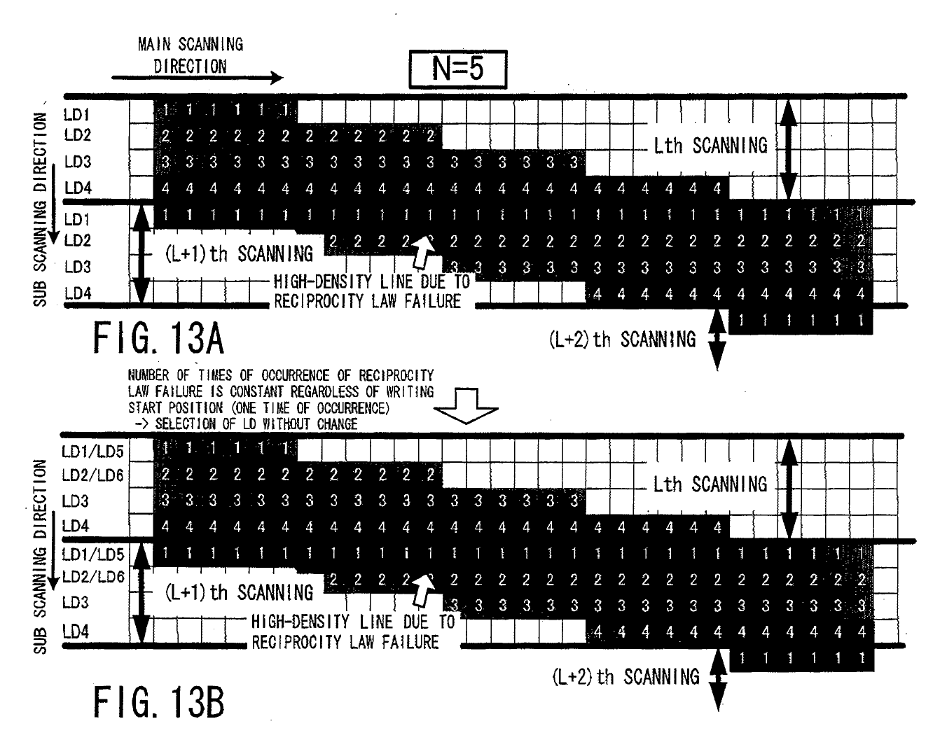

FIG. 13A is a view showing how the reciprocity law failure occurs in the conventional beam scanning method without the redundant exposure device if the dot width is N=5. When the dot width is N=5, the reciprocity law failure occurs at the writing start positions of LD1 to LD4 one by one and the occurrence number of reciprocity law failures is equalized. Accordingly, in the present embodiment, as shown in FIG. 13B, the image having the dot width N=5 is exposed using only the main exposure devices LD1 to LD4 without selecting the redundant exposure devices LD5 and LD6.

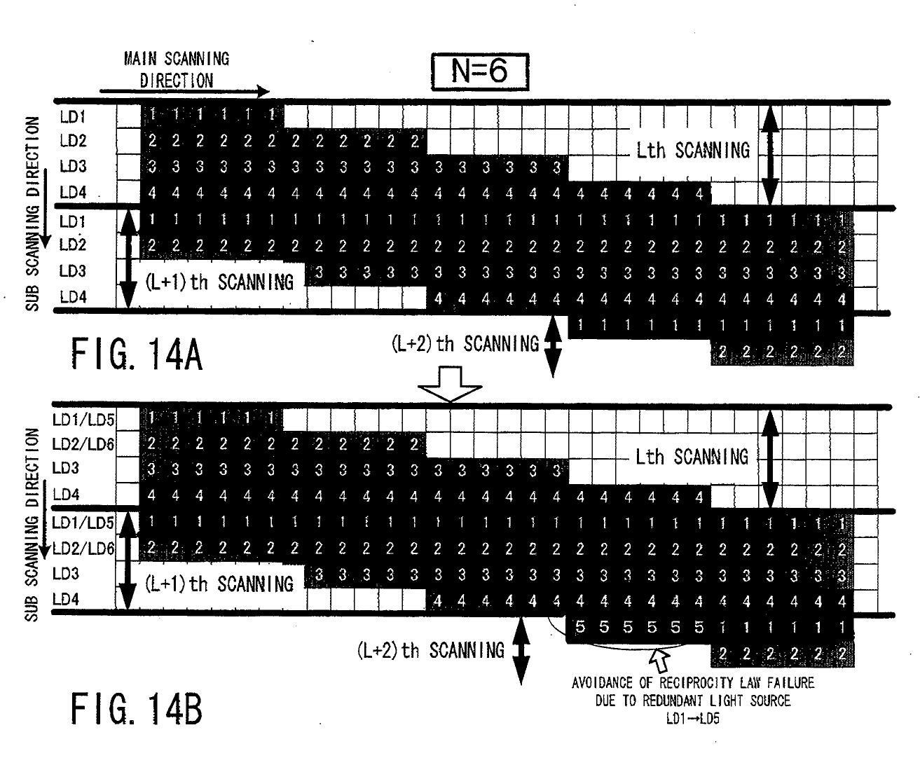

FIG. 14A is a view showing how the reciprocity law failure occurs in the conventional beam scanning method without the redundant exposure device if the dot width is N=6. When the dot width is N=6 and the writing start position is LD4, the reciprocity law failure occurs at two places in the sub scanning direction. At the other writing start positions, the reciprocity law failure occurs at one place in the sub scanning direction. Accordingly, in the present embodiment, as shown in FIG. 14B, when the writing start position is LD4, the redundant exposure device LD5 is used and the occurrence number of reciprocity law failures is decreased from 2 to 1. As a result, the occurrence number of reciprocity law failure is equalized to 1 at all the writing start position.

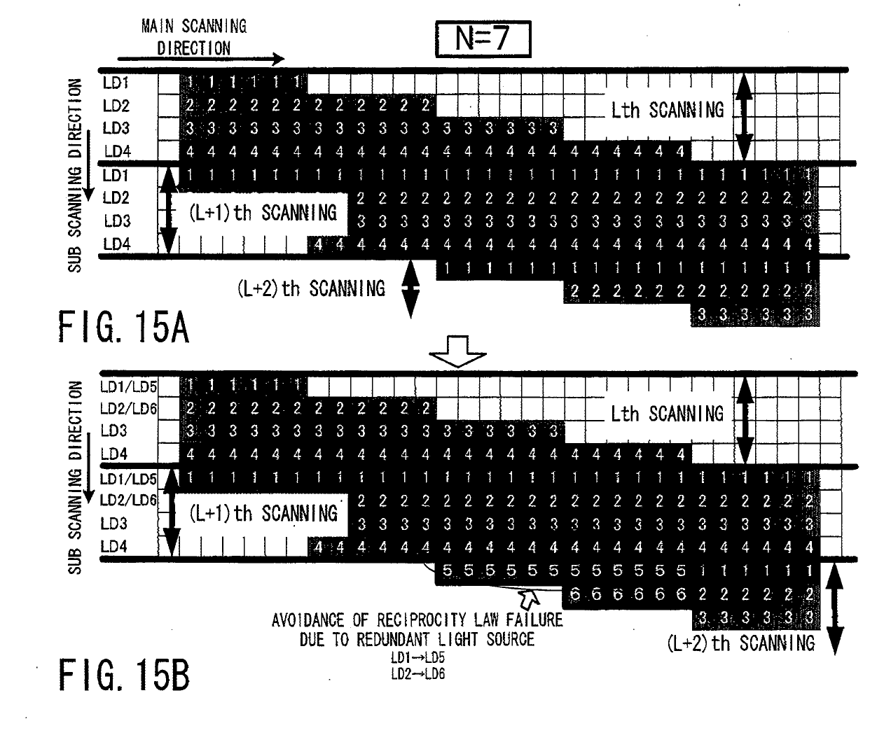

When the dot width is N=7 and the writing start position is LD3 and LD4, the reciprocity law failure occurs at two places in the sub scanning direction (FIG. 15A). In this case, the occurrence number of reciprocity law failure is equalized to 1 by using the redundant exposure devices LD5 and LD6 (FIG. 15B).

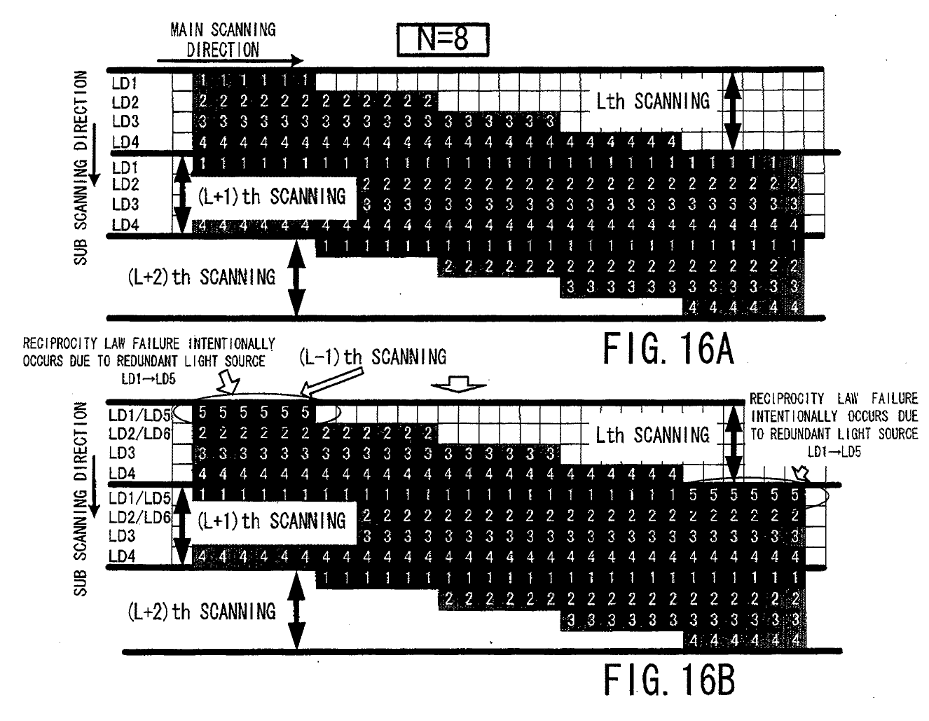

When the dot width N=8 and the writing start position is LD2, LD3 and LD4, the reciprocity law failure occurs at two places in the sub scanning direction but, when the writing start position is LD1, the reciprocity law failure occurs at one place in the sub scanning direction (FIG. 16A). In this case, similar to the case where the dot width is N=4, the occurrence number of reciprocity law failures when the writing start position is LD1 is intentionally increased from 1 to 2 such that the occurrence number of reciprocity law failures is equalized to 2 at all the writing start positions.

If the case where the dot width is N=2 (FIGS. 10A and 10B) and the case where the dot width is N=6 (FIGS. 14A and 14B) are compared, it can be seen that, if the dot width is N=6, the occurrence number of reciprocity law failures in the sub scanning direction is uniformly increased by one at all the writing start positions, compared with the case where the dot width is N=2. Similarly, if the case where the dot width is N=3 (FIGS. 11A and 11B) and the case where the dot width is N=7 (FIGS. 15A and 158) are compared, it can be seen that, if the dot width is N=7, the occurrence number of reciprocity law failures in the sub scanning direction is uniformly increased by one at all the writing start positions, compared with the case where the dot width is N=3. In addition, if the case where the dot width is N=4 (FIGS. 12A and 12B) and the case where the dot width is N=8 (FIGS. 16A and 16B) are compared, it can be seen that, if the dot width is N=8, the occurrence number of reciprocity law failures in the sub scanning direction is uniformly increased by one at all the writing start positions, compared with the case where the dot width is N=4.

The method of selecting the redundant exposure device necessary for equalizing the occurrence number of reciprocity law failures regardless of the writing start position is identical when the dot width is N=2 and N=6 (FIG. 10B and FIG. 14B). Similarly, even when the dot width is N=3 and N=7 (FIG. 11B and FIG. 15B) and the dot width is N=4 and N=8 (FIG. 12B and FIG. 16B), the method of selecting the redundant exposure device necessary for equalizing the occurrence number of reciprocity law failures regardless of the writing start position is completely identical. This indicates that, when the number of main exposure devices is n (n=4 in the example), the method when the dot width N is from N=2 to N=n+1 can be applied to the method of selecting the redundant exposure device necessary for equalizing the occurrence number of reciprocity law failures when the dot width N is equal to or greater than n+2 (6 or more in the example).

That is, if the method of selecting the redundant exposure device can be established when the dot width N is from N=2 to N=n+1, the same method may be applied to the dot width of N=n+2 or more.

Hereinafter, the generalization of the number m of redundant exposure device necessary for equalizing the occurrence number of reciprocity law failures regardless of the writing start position when the number of main exposure devices is n will be described. In this case, the dot width N is N=2 to N=n+1.

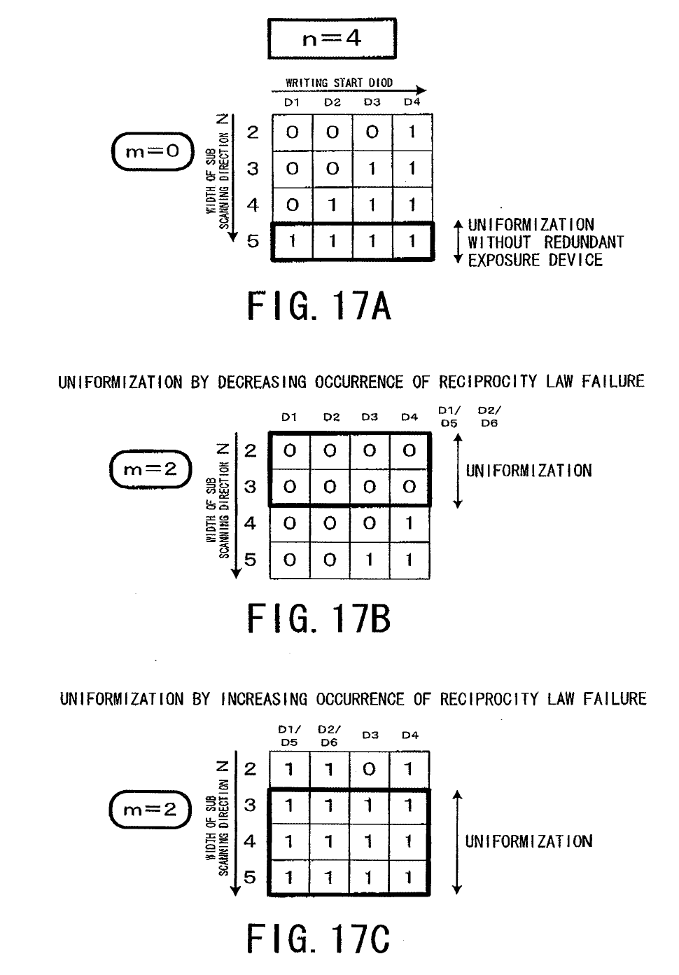

FIGS. 17A to 17C are views showing the result of examining the number m of redundant exposure devices necessary for equalizing the occurrence number of reciprocity law failures regardless of the writing start position when the number n of main exposure devices is 4. Among them, FIG. 17B is a view showing the result of examining the number m of redundant exposure devices necessary for equalizing the occurrence number of reciprocity law failures regardless of the writing start position by decreasing the occurrence number of reciprocity law failures. FIG. 17C is a view showing the result of examining the number m of redundant exposure devices necessary for equalizing the occurrence number of reciprocity law failures regardless of the writing start position by increasing the occurrence number of reciprocity law failures.

In FIGS. 17A to 17C, a horizontal axis of a matrix represents the main exposure devices D1 to D4 corresponding to the writing start positions and a vertical axis represents the dot width N of the sub scanning direction. A numeral in the matrix represents the occurrence number of reciprocity law failures.

In a first row of the matrix of FIG. 17A, when the number m of redundant exposure devices is 0 and the image having the dot width 2 is desired to be exposed, the occurrence number of reciprocity law failure is 0 at the writing start positions of D1 to D3 and the occurrence number of reciprocity law failure is 1 at the writing start position of D4 (this corresponds to FIG. 10A) In a second row of the matrix of FIG. 17A, when the image having the dot width 3 is exposed, the occurrence number of reciprocity law failure is 0 at the writing start positions of D1 and D2 and the occurrence number of reciprocity law failure is 1 at the writing start positions of D3 and D4 (this corresponds to FIG. 11A). In a third row of the matrix of FIG. 17A, when the image having the dot width 4 is exposed, the occurrence number of reciprocity law failure is 0 at the writing start position of D1 and the occurrence number of reciprocity law failure is 1 at the writing start positions of D2, D3 and D4 (this corresponds to FIG. 12A) That is, in the first to third rows of the matrix, the occurrence number of reciprocity law failures is not equalized by the writing start position.

When the image having the dot width 5 is exposed (a fourth row of the matrix of FIG. 17A), the occurrence number of reciprocity law failures is 1 at all the writing start positions of D1 to D4 (this corresponds to FIGS. 13A and 13B). That is, in the image having the dot width 5, the occurrence number of reciprocity law failures is equalized even when the number m of redundant exposure devices is 0. When the occurrence number of reciprocity law failures is identical (equalized) regardless of the writing start position, all the rows of the matrix thereof are surrounded by a thick frame.

The matrix of FIG. 17B corresponds to the case where the number m of redundant exposure devices is 2 (D5 and D6 are added) By adding D5, the image having the dot width 2 (the first row of the matrix) can be exposed by one-time scanning by D4 and D5 even when the writing start position is D4 and the reciprocity law failure does not occur (this corresponds to FIG. 10B). Similarly, even when the writing start position is D4, the image having the dot width 3 (the second row of the matrix) can be exposed by one-time scanning using D4, D5 and D6 and the reciprocity law failure does not occur (this corresponds to FIG. 11B). With respect to the images having the dot widths N of 2 and 3, the occurrence number of reciprocity law failures can be equalized to zero regardless of the writing start position by decreasing the occurrence of the reciprocity law failure.

Meanwhile, the matrix of FIG. 17C corresponds to the case where the occurrence of the reciprocity law failure is increased and equalized when the number m of redundant exposure devices is 2 (D5 and D6 are added). With respect to the image having the dot width 4 (the third row of the matrix) the occurrence number of reciprocity law failures can be increased from zero to 1 by changing first scanning using D1, D2, D3 and D4 to second scanning using D5, D2, D3 and D4 (this corresponds to FIG. 12). Even with respect to the image having the dot width 3, the occurrence number of reciprocity law failures can be increased from zero to 1 by changing one-time scanning using D1, D2 and D3 to two-time scanning using D5, D6 and D3 or D5, D2 and D3 and changing one-time scanning using D2, D3 and D4 to two-time scanning using D6, D3 and D4.

As can be seen from FIGS. 17B and 17C, when the number n of main exposure devices is 4 and the number m of redundant exposure devices is 2, the occurrence number of reciprocity law failures can be equalized regardless of the writing start position in the dot width N of 2 to 5.

In FIGS. 17A to 17C, the dot width N of the image in the sub scanning direction is in a range from 2 to n+1 (=5). However, the reason why the occurrence number of reciprocity law failures can be equalized although the dot width N is further increased is as stated above.

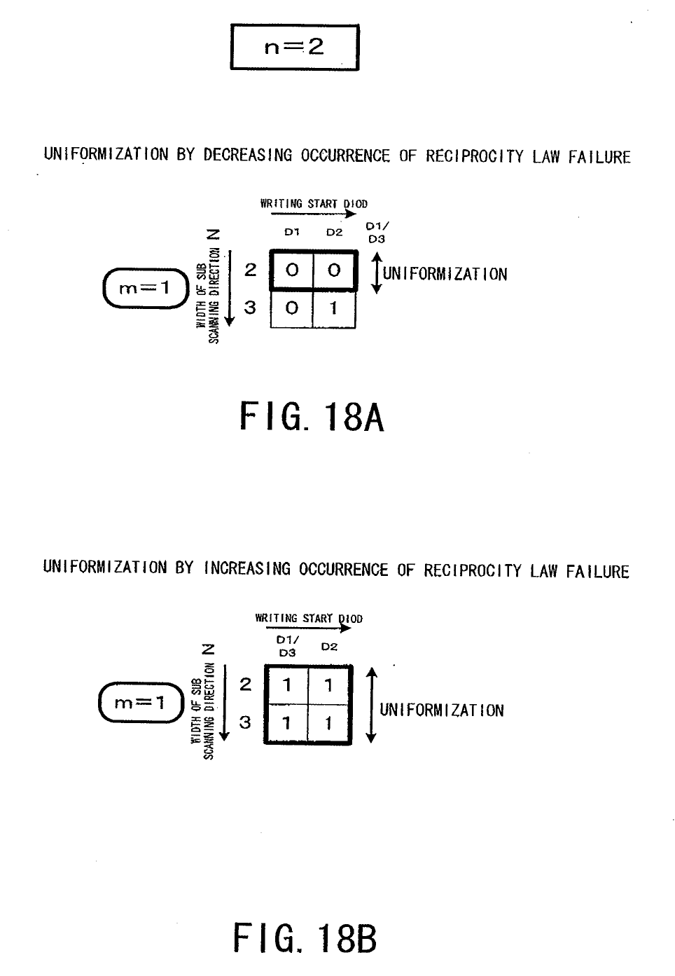

FIGS. 18A and 18B show the result of examining the number of redundant exposure devices when the number of main exposure devices is n=2. If the number m of redundant exposure devices is m=1, the occurrence number of reciprocity law failures can be equalized.

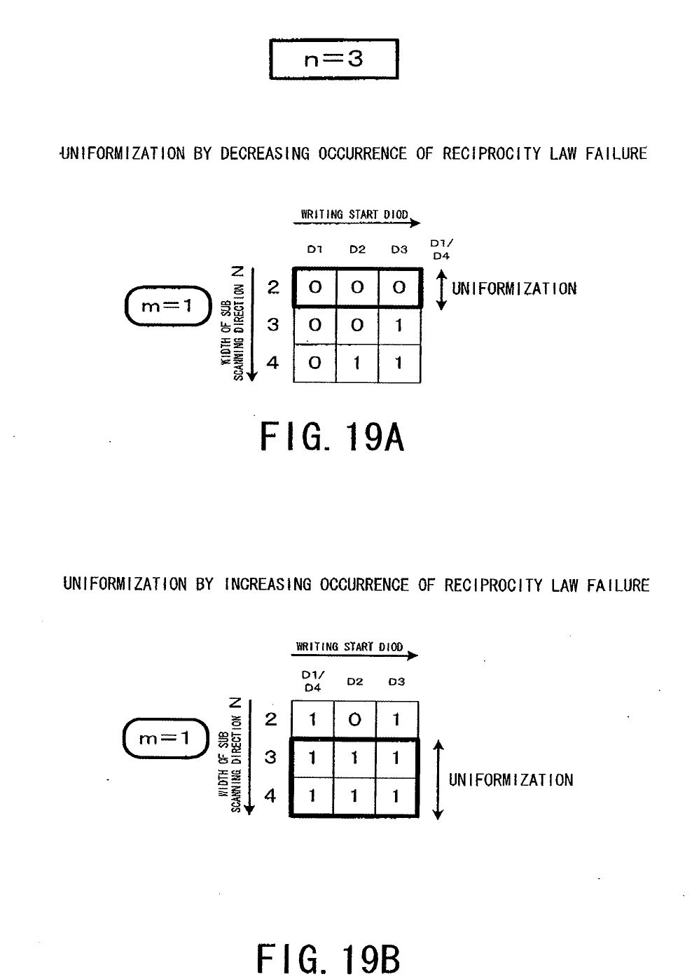

Even when the number of main exposure devices is n=3, as shown in FIGS. 19A and 19B, if m=1, the occurrence number of reciprocity law failures can be equalized.

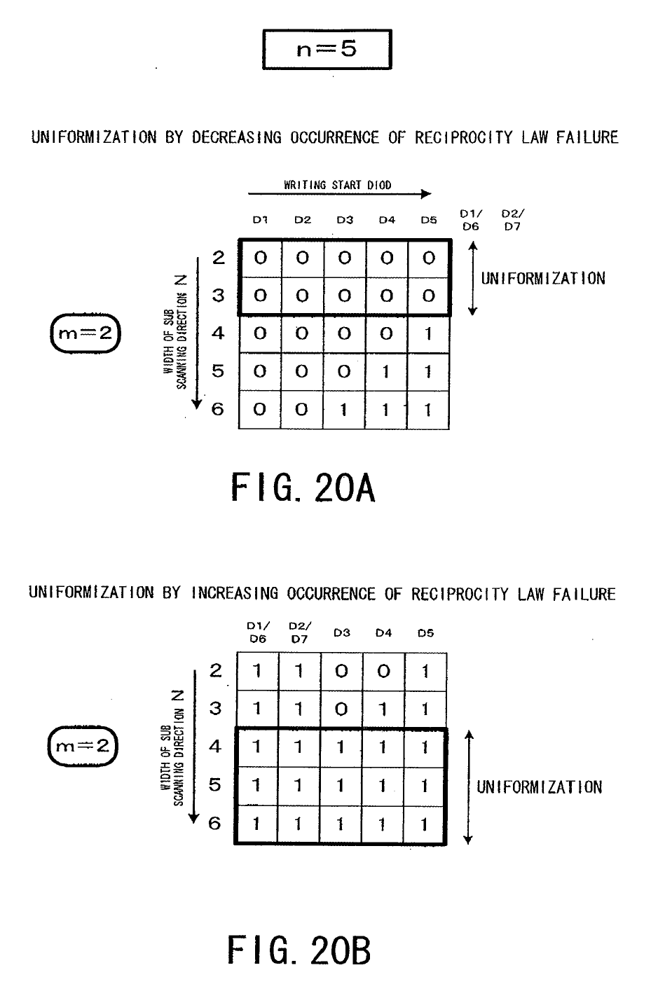

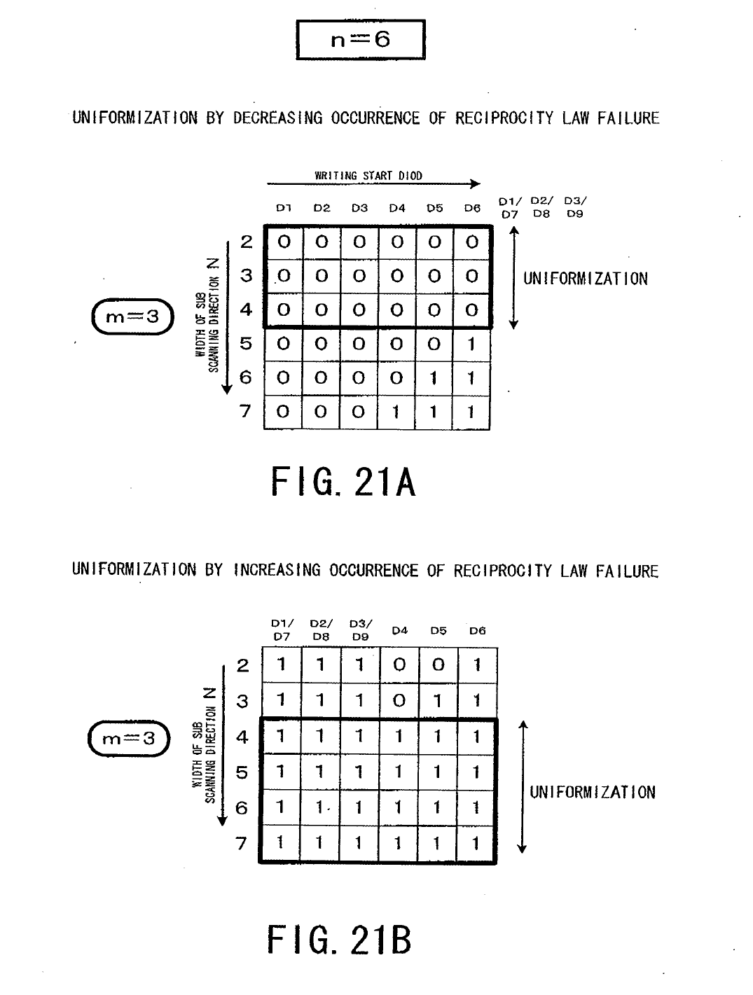

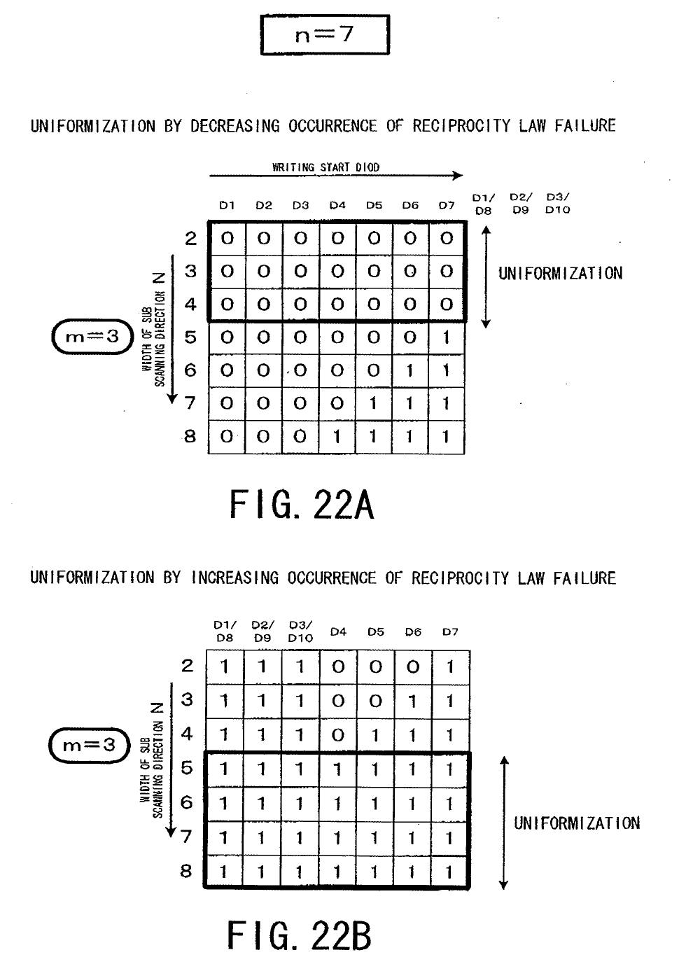

Hereinafter, similarly, the minimum number of redundant exposure devices necessary for equalizing the occurrence of the reciprocity law failures becomes m=2 when the number of main exposure devices is n=5 (FIG. 20A and FIG. 20B), m=3 when the number of main exposure devices is n=6 (FIG. 21A and FIG. 21B), and m=3 when the number of main exposure devices is n=7 (FIG. 22A and FIG. 22B).

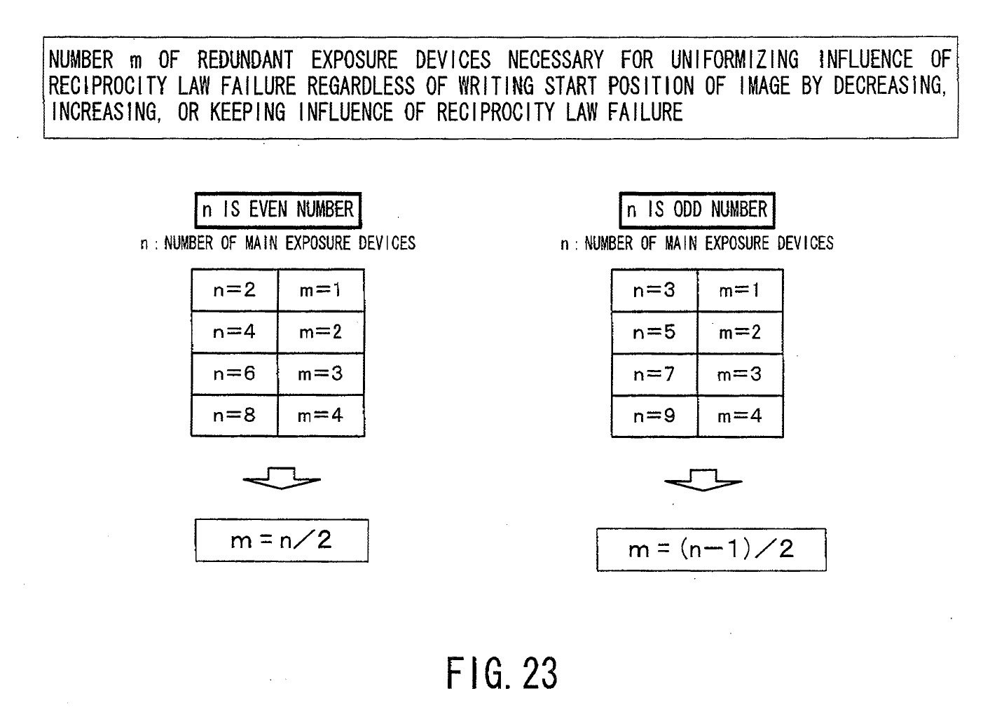

The collection of FIG. 17B, FIG. 17C, FIG. 18A, FIG. 18B, FIG. 19A, FIG. 19B, FIG. 20A, FIG. 20B, FIG. 21A, FIG. 21B, FIG. 22A and FIG. 22B is shown in FIG. 23. FIG. 23 is a view showing a minimum value of the number m of necessary redundant exposure devices in the beam scanning method (first embodiment) for equalizing the occurrence of reciprocity law failures regardless of the writing start position by selecting one of the redundant exposure devices which are added and the main exposure devices positioned at the same positions of the redundant exposure devices and increasing or decreasing (or keeping) the occurrence (influence) of the reciprocity law failures.

In FIGS. 23A and 23B, the result of examining the numbers of main exposure devices of n=8 and n=9 is added.

A left table of FIG. 23 shows the examined result when the number n of the main exposure devices is an even number. As a result, m=1 if n is 2, m=2 if n is 4, m=3 if n is 6, and m=4 if n is 8. That is, if the number n of main exposure devices is an even number, it is deductively obtained that the minimum value of redundant exposure devices m is

m=n/2. Equation 1

A right table of FIG. 23 shows the examined result when the number n of the main exposure devices is an odd number. As a result, m=1 if n is 3, m=2 if n is 5, m=3 if n is 7, and m=4 it n is 9. That is, if the number n of main exposure devices is an odd number, it is deductively obtained that the minimum value of redundant exposure devices m is

m=(n−1)/2. Equation 2

Since m and n are natural numbers, when Equation 1 and Equation 2 are added, the minimum value of the redundant exposure devices m is a minimum integer satisfying

m≧(n−1)/2 Equation 3

Since the total number k of exposure devices is k=m+n, n=k−m is substituted for Equation 3 and the minimum value of the redundant exposure devices m is a minimum integer satisfying

m≧(k−1)/3 Equation 4

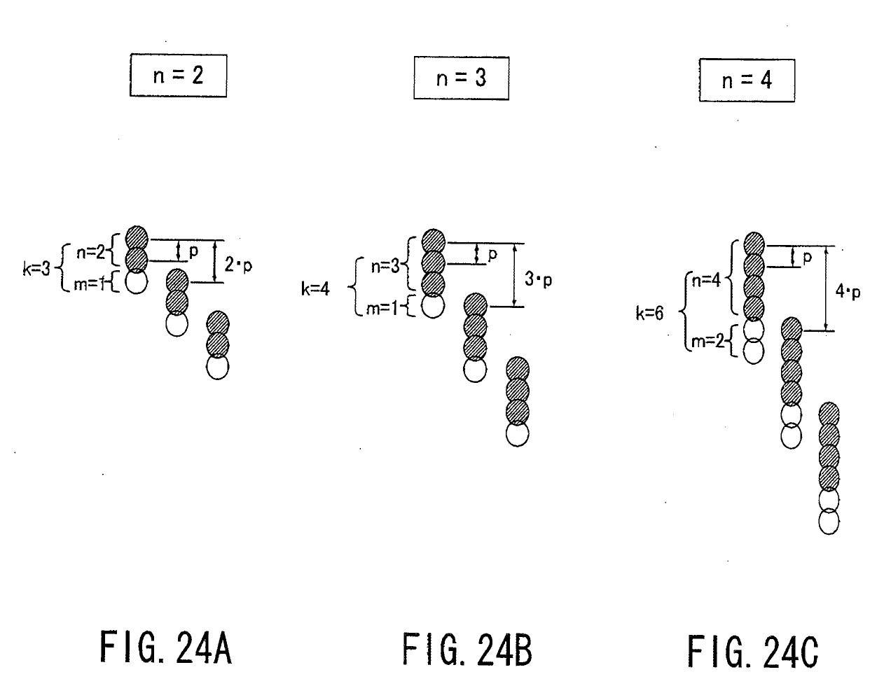

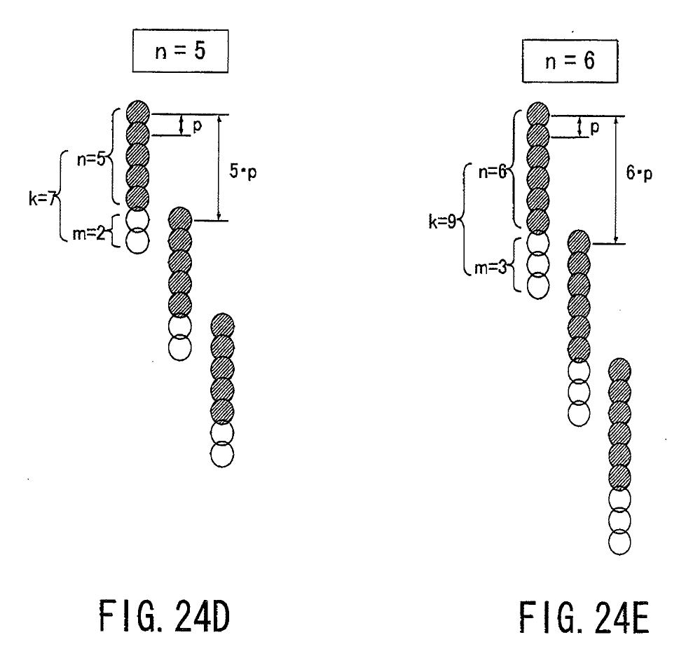

FIGS. 24A to 24E are views showing detailed examples of the number m of redundant exposure devices obtained by Equation 1 and Equation 2 and the beam scanning method when the number n of main exposure devices is 2 to 6.

Although, in the above description, the minimum number m of redundant exposure devices is obtained under the condition that the number n of main exposure devices or the dot width N of the image is an integer of 2 or more, the minimum number m of redundant exposure devices can be further decreased if the condition that the number n of main exposure devices is a multiple of 4 and the dot width N of the image is a positive even number is added thereto.

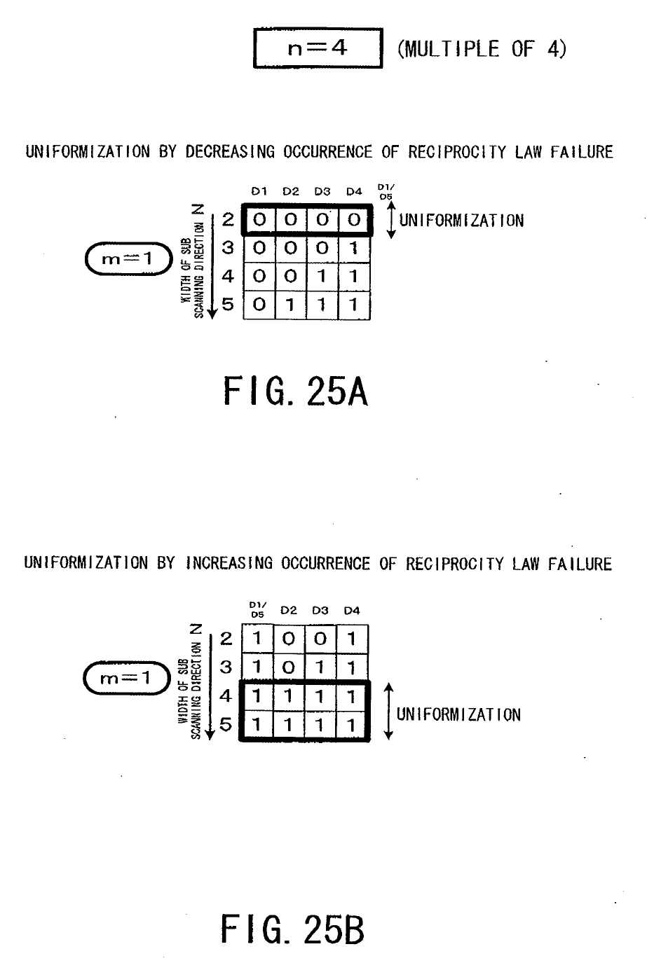

FIGS. 25A and 25B show the equalization of the occurrence of the reciprocity law failures with respect to the even-numbered dot width N=2, 4 if the number n of main exposure devices is 4 and the number m of redundant exposure devices is 1.

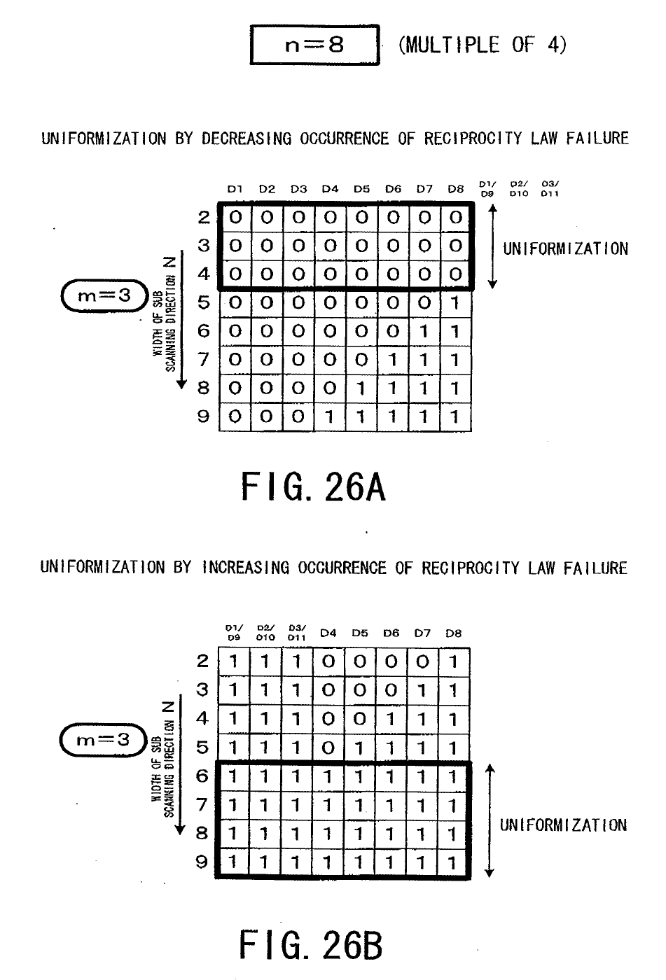

FIGS. 26A and 26B show the equalization of the occurrence of the reciprocity law failures with respect to the even-numbered dot width N=2, 4, 6, 8 if the number n of main exposure devices is 8 and the number m of redundant exposure devices is 3.

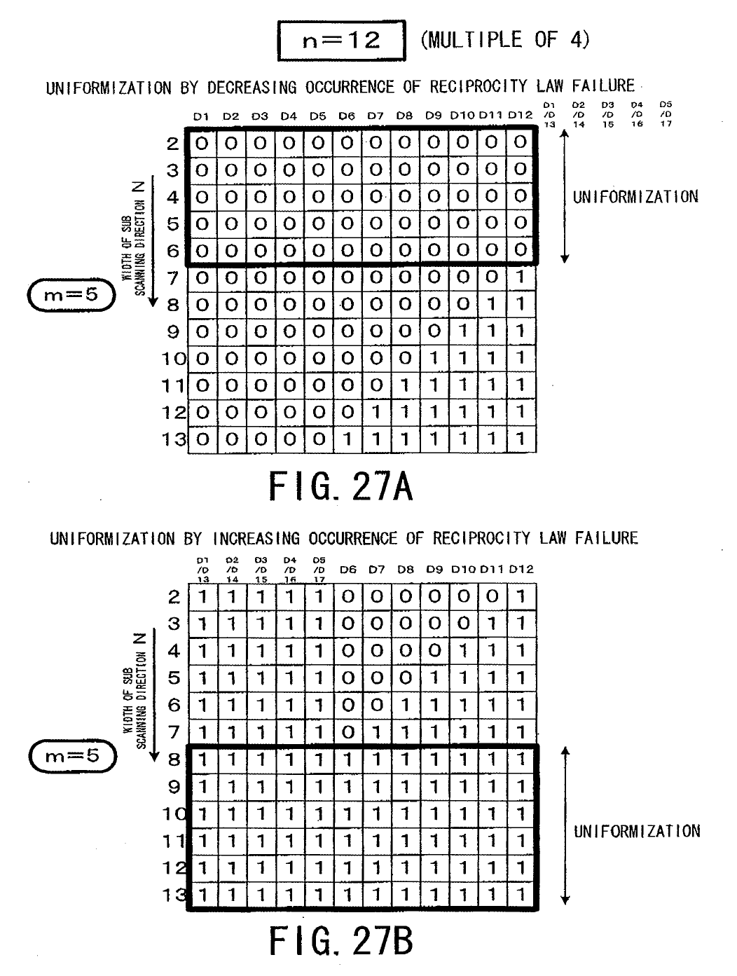

Similarly, FIGS. 27A and 27B show the equalization of the occurrence of the reciprocity law failures with respect to the even-numbered dot width N=2, 4, 6, 8, 10, 12 if the number n of main exposure devices is 12 and the number m of redundant exposure devices is 5.

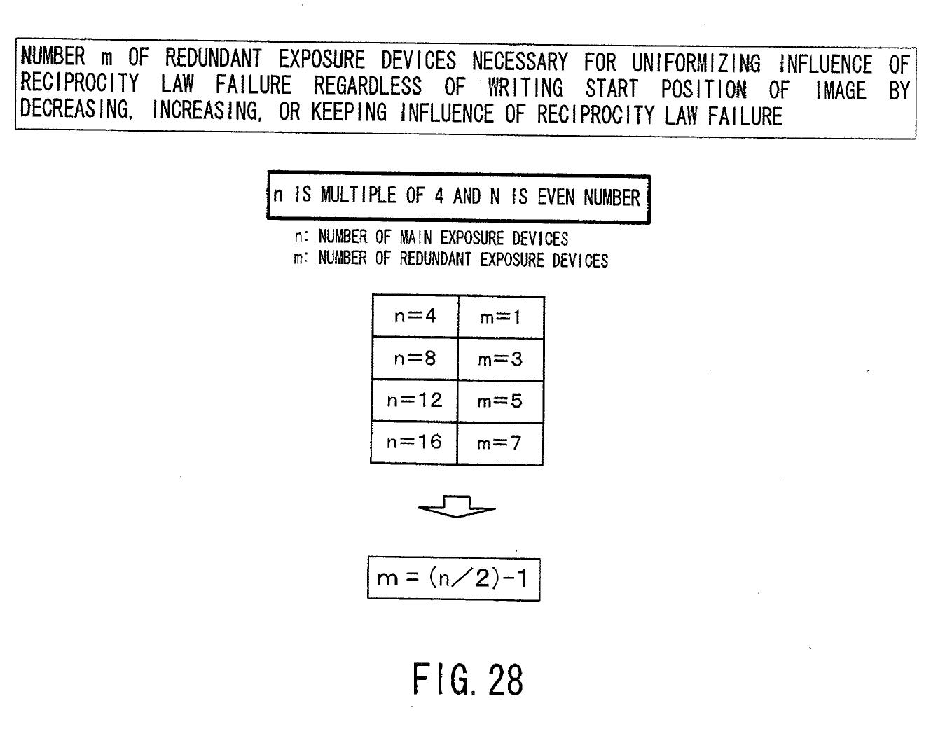

FIG. 28 is a view showing the result of adding the examined result when the number n of main exposure devices is 16 to the examined result above

As can be seen from FIG. 28, when the number n of main exposure devices is a multiple of 4, the dot width N of the image is a positive even number, the number m of redundant exposure devices is 1 when the number n of main exposure devices is 4, m is 3 when n is 8, m is 5 when n is 12 and m is 7 when n is 16. When they are expressed by equation,

m=(n/2)−1 (n is a multiple of 4) Equation 5

is obtained.

For example, if the dot width N may be the even number or the odd number when the number of main exposure devices is 4, the minimum number m of necessary redundant exposure devices is 2 in Equation 1, but, if the dot width N is limited to the even number, the minimum number m of necessary redundant exposure devices can be decreased to 1. If the dot width N may be the even number or the odd number when the number of main exposure devices is 8, the minimum number m of necessary redundant exposure devices is 4, but, if the dot width N is limited to the even number, the minimum number m of necessary redundant exposure devices can be decreased to 3.

For example, if the physical dot pitch p of the sub scanning direction is 2400 dpi and the resolution of the image data or the halftone pattern is 1200 dpi, two adjacent dots always forms a pair in the sub scanning direction and thus corresponds to the above condition that the dot width N is the even number. Accordingly, when the dot width is the even number, decrease in the number m of redundant exposure devices in accordance with Equation 5 is much worthwhile.

When m=k−n is substituted for Equation 5, k becomes

k=(3n/2)−1 (n is a multiple of 4) Equation 6

In the above description, the minimum number m of necessary redundant exposure devices is obtained by decreasing and increasing the occurrence of reciprocity law failures. In contrast, the occurrence of reciprocity law failures can be equalized regardless of the writing start position without increasing (that is, by decreasing and keeping) the occurrence of reciprocity law failures. Similarly, the occurrence of reciprocity law failures can be equalized regardless of the writing start position without decreasing (that is, by increasing and keeping) the occurrence of reciprocity law failures. The minimum number m of necessary redundant exposure devices in this case will be described below.

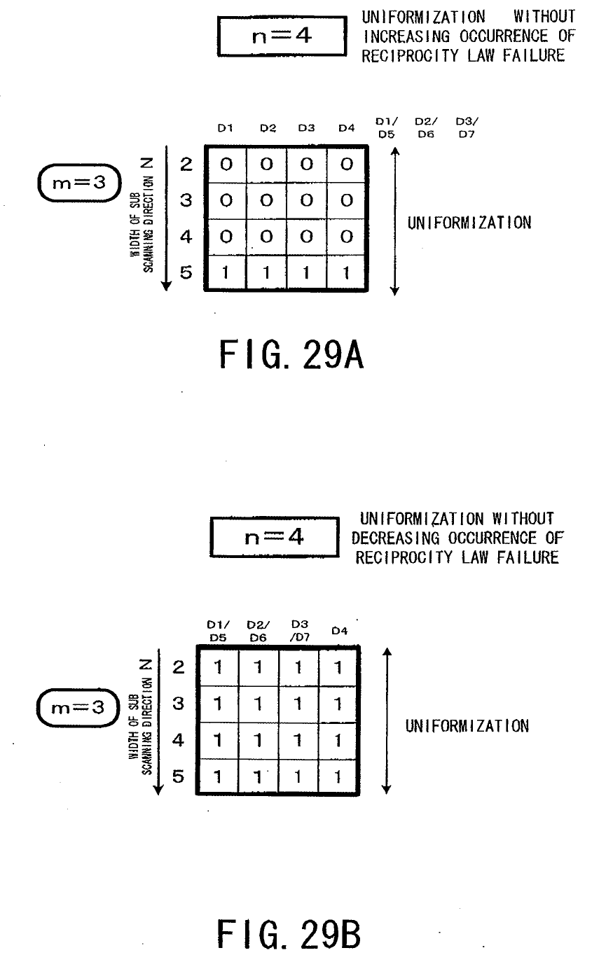

FIG. 29A shows that the minimum number m of necessary redundant exposure devices is 3 in order to equalize the occurrence of reciprocity law failures without increasing when the number of main exposure devices is 4. If the number m of redundant exposure devices is 3, the occurrence number of reciprocity law failures is equalized to zero with respect to the dot width N of the sub scanning direction of 2 to 4. If the dot width N is 5, the occurrence number of reciprocity law failures is equalized to 1 at all the writing start positions without using the redundant exposure device as described above.

FIG. 29B shows that the occurrence of reciprocity law failures can be equalized without decreasing when the number n of redundant exposure devices is 3 and the number of main exposure devices is 4. If the number m of redundant exposure devices is 3, the occurrence number of reciprocity law failures is equalized to 1 regardless of the writing start position with respect to the dot width N of the sub scanning direction of 2 to 5.

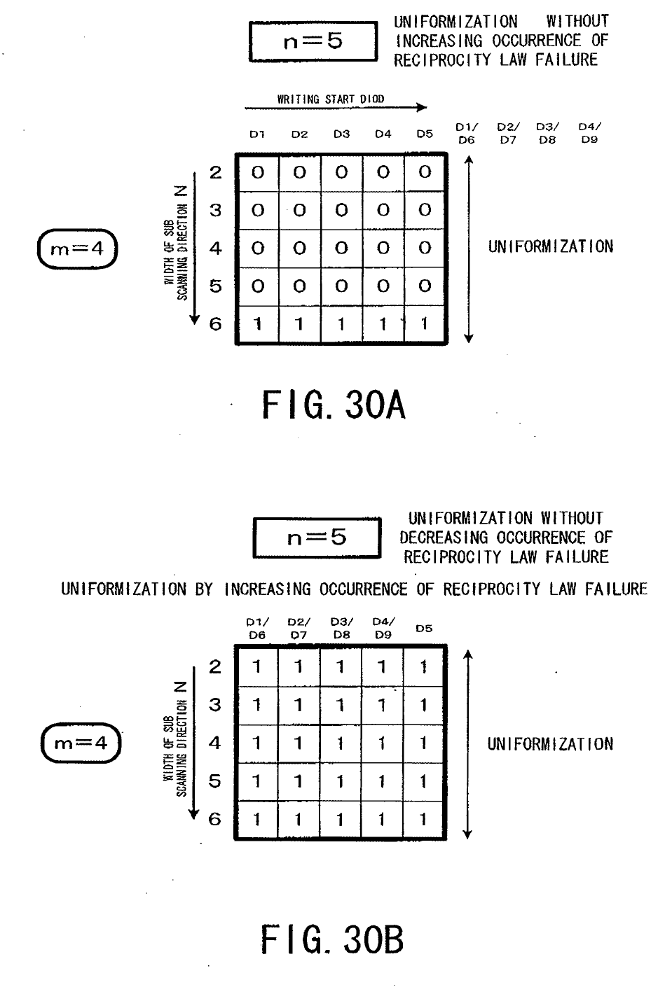

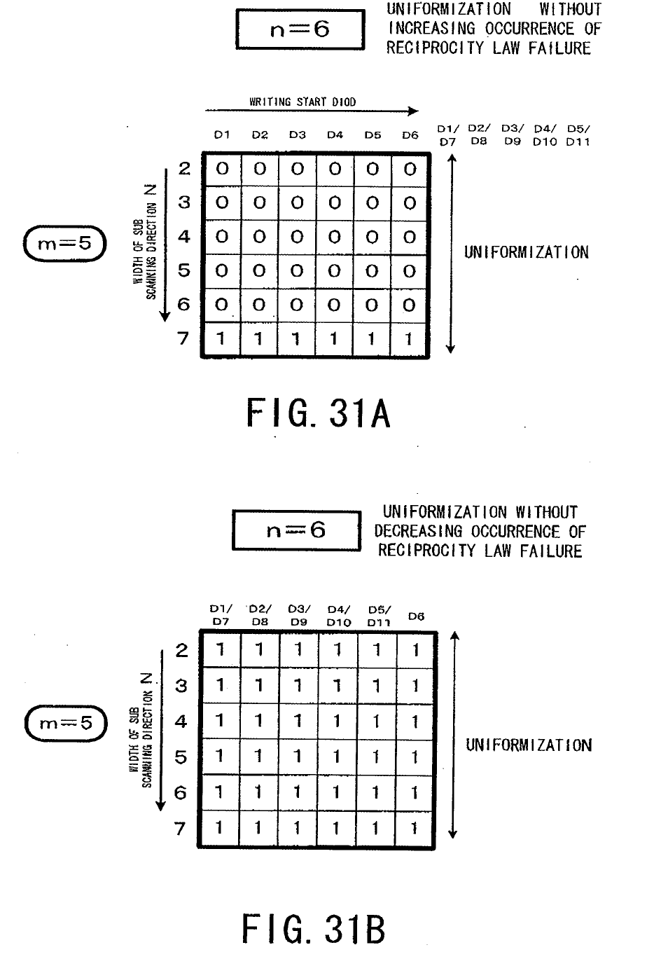

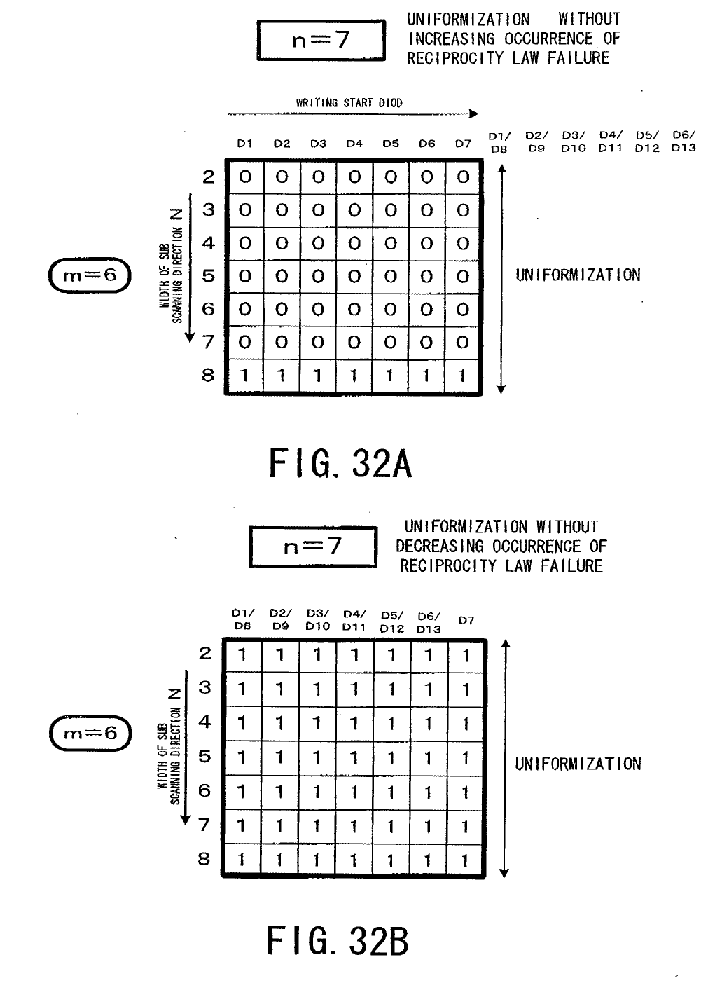

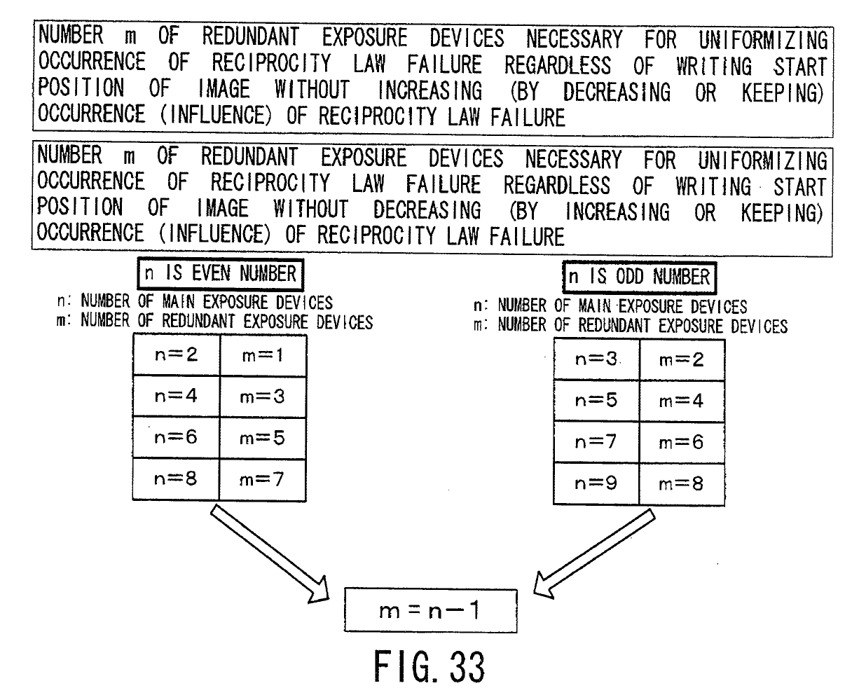

FIG. 30A and FIG. 30B to FIG. 32A and 32B show the results of performing the same examination when the number of main exposure devices is n=5, 6, 7. In addition to the examined results, the result of performing the examination when n=2, 3, 8, 9 is shown in FIG. 33. As can be seen from FIG. 33, the minimum number m of necessary redundant exposure devices becomes m=1, 2, 3, 4, 5, 6, 7, 8 with respect to the number of main exposure devices n=2, 3, 4, 5, 6, 7, 8, 9. When this is expressed by the equation,

m=n−1 Equation 7

is obtained.

### (3) Beam Scanning Method (Second Embodiment)

The occurrence number of reciprocity law failures in the sub scanning direction can be equalized by the beam scanning method according to the first embodiment. However, adjacent pixels in the same horizontal line in the main scanning direction may be exposed by two-time scanning. In this case, the reciprocity law failure occurs in the main scanning direction and a new density difference may occur.

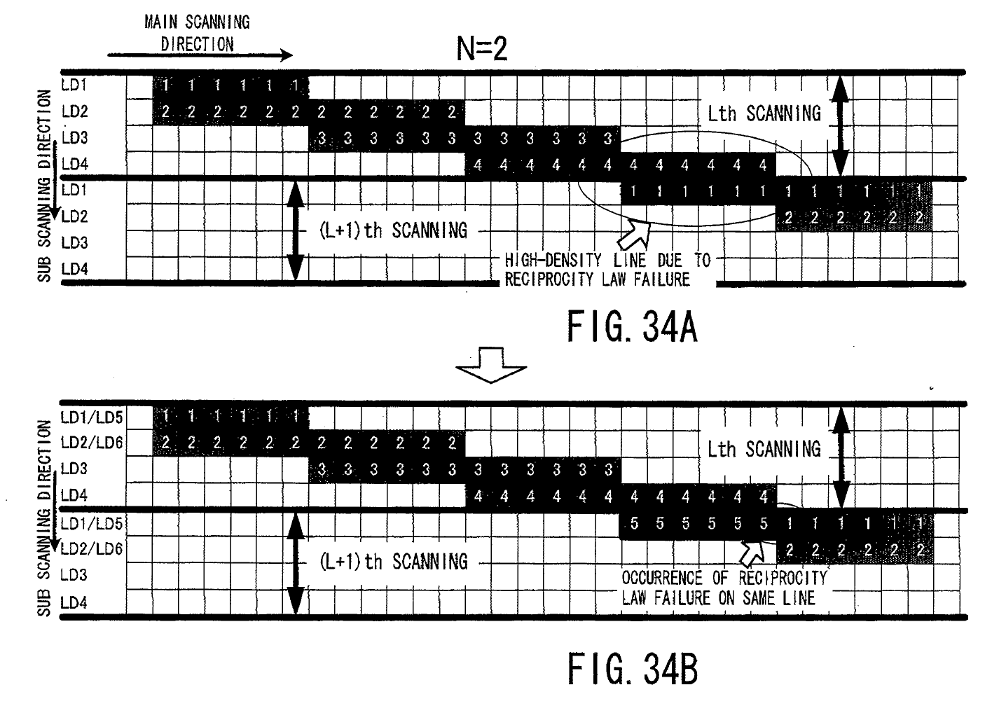

FIGS. 34A and 34B are views illustrating a situation in which the reciprocity law failure occurs in the main scanning direction. FIGS. 34A and 34B show the completely same beam scanning as FIGS. 10A and 10B. In FIG. 34A, the reciprocity law failure of the sub scanning direction which occurs in the image of the fourth stage from the left side can be solved by using the redundant exposure device LD5 as described above (FIG. 34B).

However, in FIG. 34B, LD5 is switched to LD1 in a boundary between the image of the fourth stage from the left side and the image of the fifth stage from the left side. In the boundary of the main scanning direction, Lth scanning is performed using LD4 and LD5 and (L+1)th scanning is performed using LD1 and LD2. As a result, pixels adjacent in the main scanning direction are exposed by two-time scanning and have a high density due to the influence of the reciprocity law failure. Strictly speaking, since the diameter of the beam spot of the laser beam is slight larger than the size of the pixel, the periphery of two adjacent pixels are influenced by the reciprocity law failure.

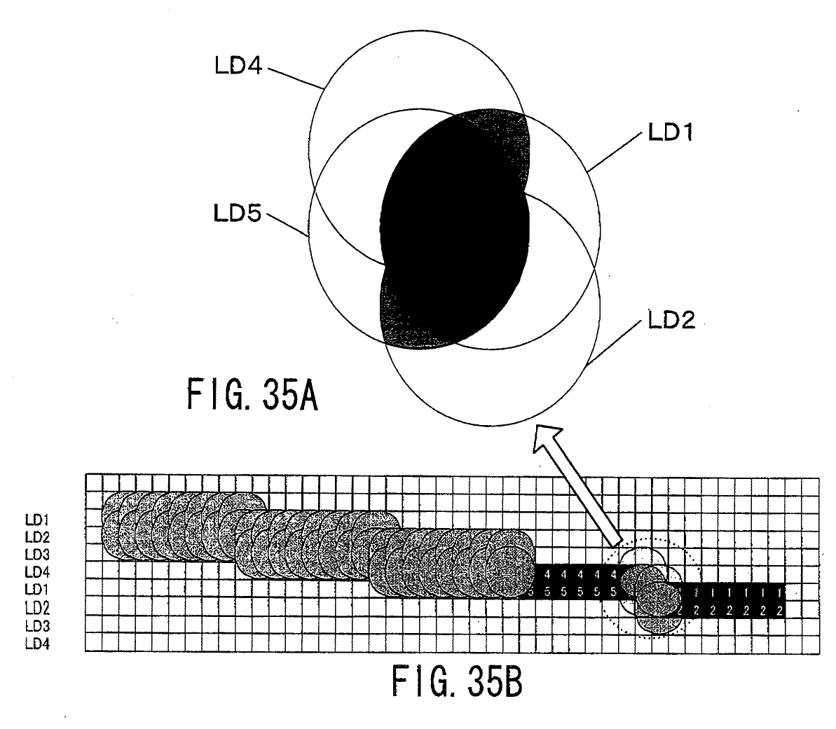

FIGS. 35A and 35B are views showing the influence of the reciprocity law failure. FIG. 35A schematically shows a region overlapping with the beam spot. When the diameter of the laser beam is about 60 μm and the pitch between the beams in the sub scanning direction is about 21 μm, the overlapping area of the pair LD5 and LD1 is the largest and the overlapping areas of the pair LD4 and LD1 and the pair LD5 and LD2 are smaller than that of the pair LD5 and LD1. LD4 and LD2 overlaps with each other, but the overlapping area thereof is smaller.

In the beam scanning method according to the second embodiment, a method of decreasing the influence of the reciprocity law failure due to overlapping by controlling the exposure energy of the laser beam is used.

Although the exposure energy is controlled in consideration of all overlapping, the exposure energy may be controlled with respect to the overlapping portion between LD5 and LD1 having the largest overlapping area.

A first method of controlling the exposure energy is a method of controlling the laser power so as to decrease at least one of peak power of the writing completion of LD5 and peak power of writing start of LD1 to be lower than general peak power such that a density difference does not occur. That is, it is the method of adjusting the exposure energy by the absolute value of laser power.

A second method of controlling the exposure energy is a method of controlling the laser pulse width so as to decrease at least one of a laser pulse width of the writing completion of LD5 and a laser pulse width of the writing start of LD1 to be shorter than a general pulse width such that a density difference does not occur. That is, it is the method of adjusting the exposure energy by the exposing time.

According to the beam scanning method of the second embodiment, it is possible to avoid the influence of the reciprocity law failure which occurs in the main scanning direction by controlling the peak power or the pulse width of the laser.

### (4) Beam Scanning Method (Third Embodiment)

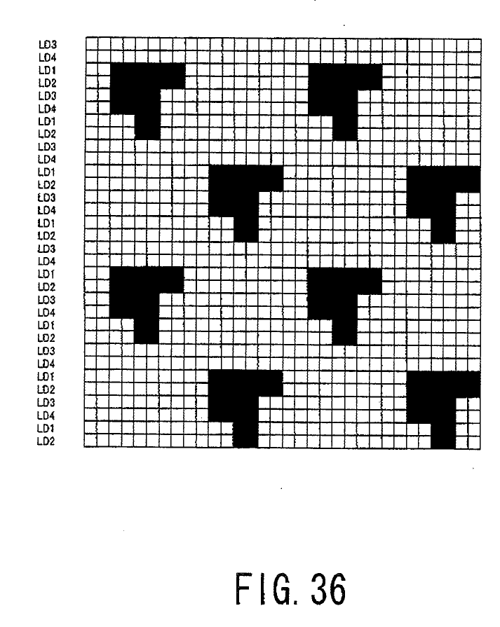

When the halftone of the image is expressed, a halftone pattern is often used. The halftone pattern indicates the two-dimensional arrangement of element patterns having a predetermined shape with a predetermined separation as shown in FIG. 36. The shape or the arrangement separation of the element patterns are previously decided according to the levels of the halftone to be expressed. FIG. 36 shows an example of forming a halftone pattern of a pair of two dots adjacent in the sub scanning direction (accordingly, an actual resolution becomes two dots instead of one dot) using four multi-beams of the four laser diodes LD1 to LD4.

Even when the halftone pattern is exposed using the multi-beam, one element pattern may be exposed by two-time (or more) scanning and the reciprocity law failure occurs. As a result, a density difference between a region in which the reciprocity law failure occurs and the other region occurs and the density in the element pattern is not uniform.

In the conventional multi-beam scanning method, even when the same halftone pattern is exposed, there is a problem that the occurrence number of reciprocity law failures which occur in the element pattern varies according to the writing start position of the element pattern (for example, depending on from which of the laser diodes LD1 to LD4 writing is started.

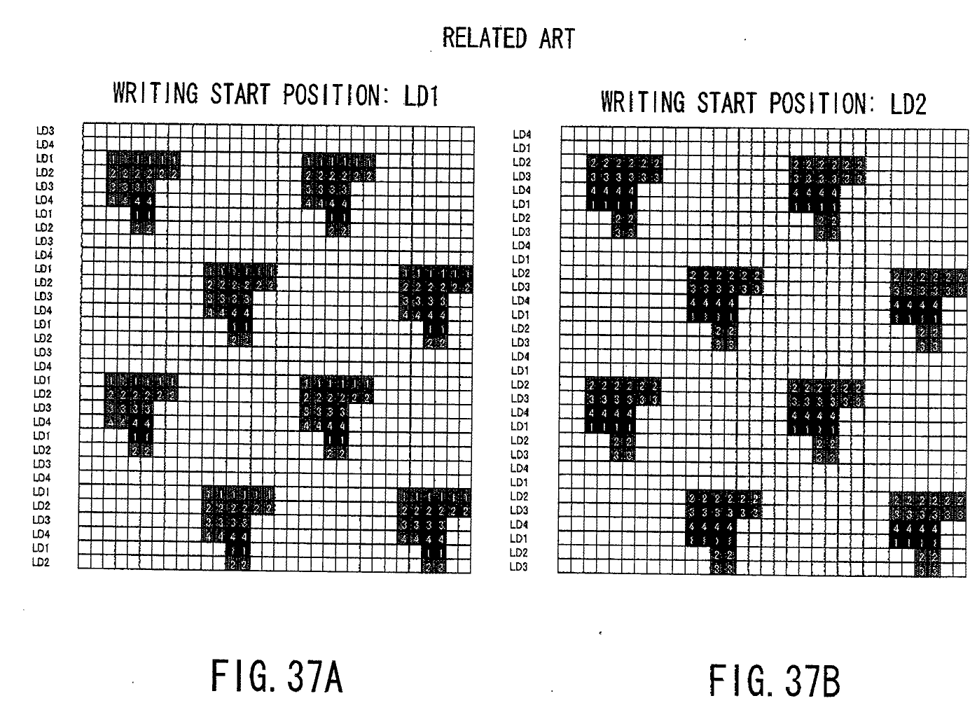

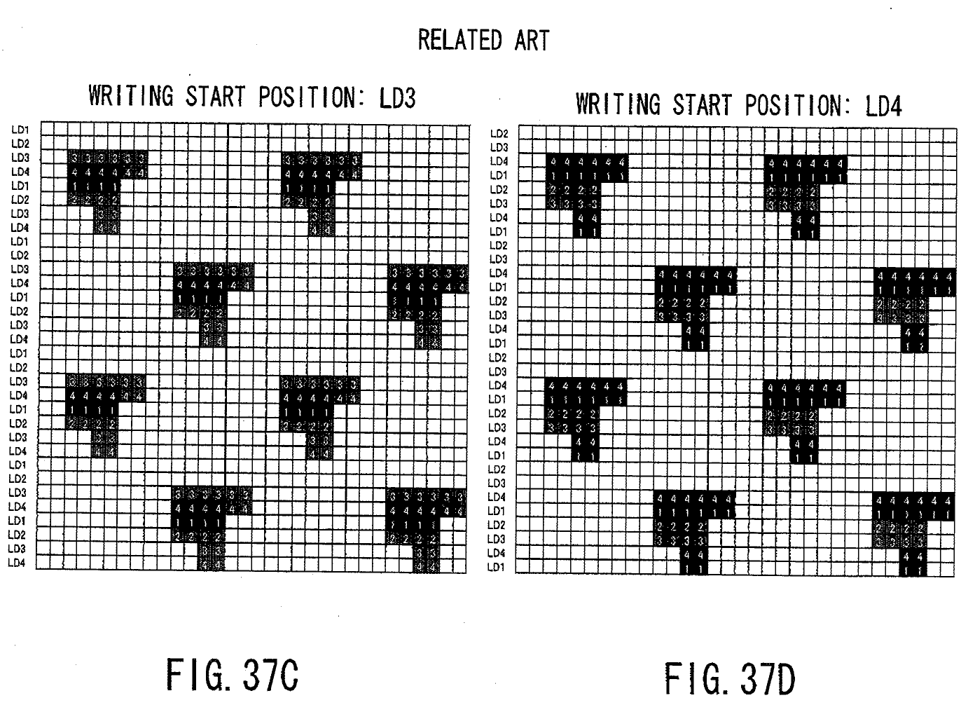

FIGS. 37A to 37D show views explaining the problem of the conventional example. In FIG. 37A, writing of the element pattern is started from LD1 and two reciprocity law failures occur. The writing of the element pattern is started from LD2 in FIG. 37B and is started from LD3 in FIG. 37C and, in these cases, four reciprocity law failures occur. In FIG. 37D, the writing of the element pattern is started from LD4, but eight reciprocity law failures occur. In the conventional method, the occurrence number of reciprocity law failures in the element pattern varies according to the writing start position of the element pattern and the density of the element pattern varies according to the writing start position.

In order to solve this problem, in the beam scanning method of the third embodiment, when the halftone pattern is exposed, the beam control is performed so that the occurrence number of reciprocity law failures in the element pattern is equalized regardless of the writing start position of the element pattern.

The element pattern may be a combination of images having the dot widths of 4, 6 and 2 in the sub scanning direction and the beam scanning method of the first embodiment may be used In this case, since the condition that the number n of main exposure devices is 4 (multiple of 4) and the dot width is the even number can be applied, the number m of necessary redundant exposure devices becomes one from Equation 5.

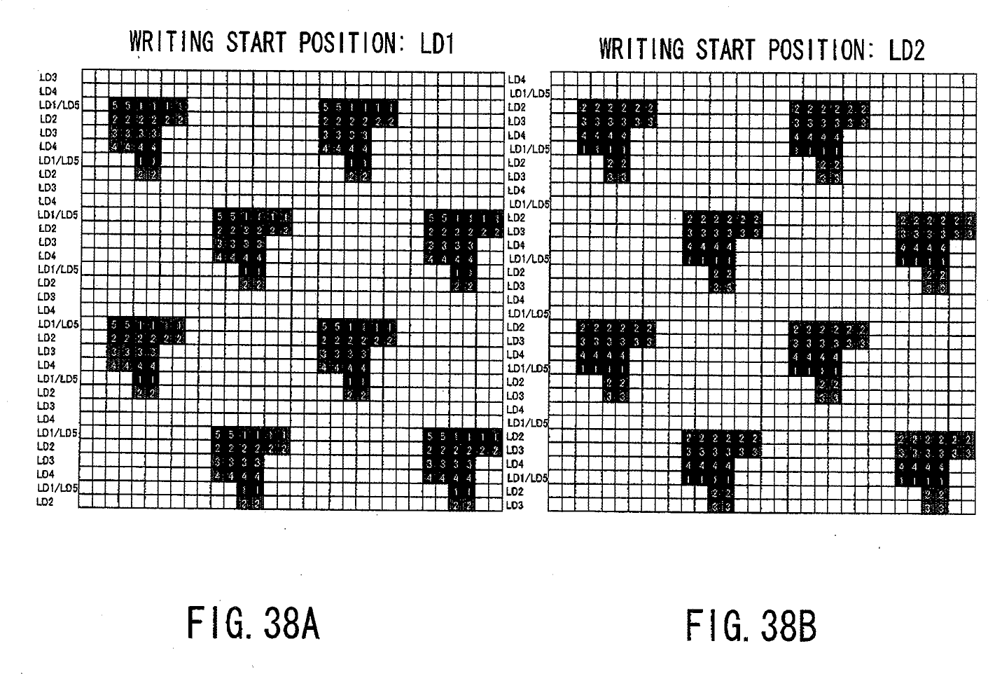

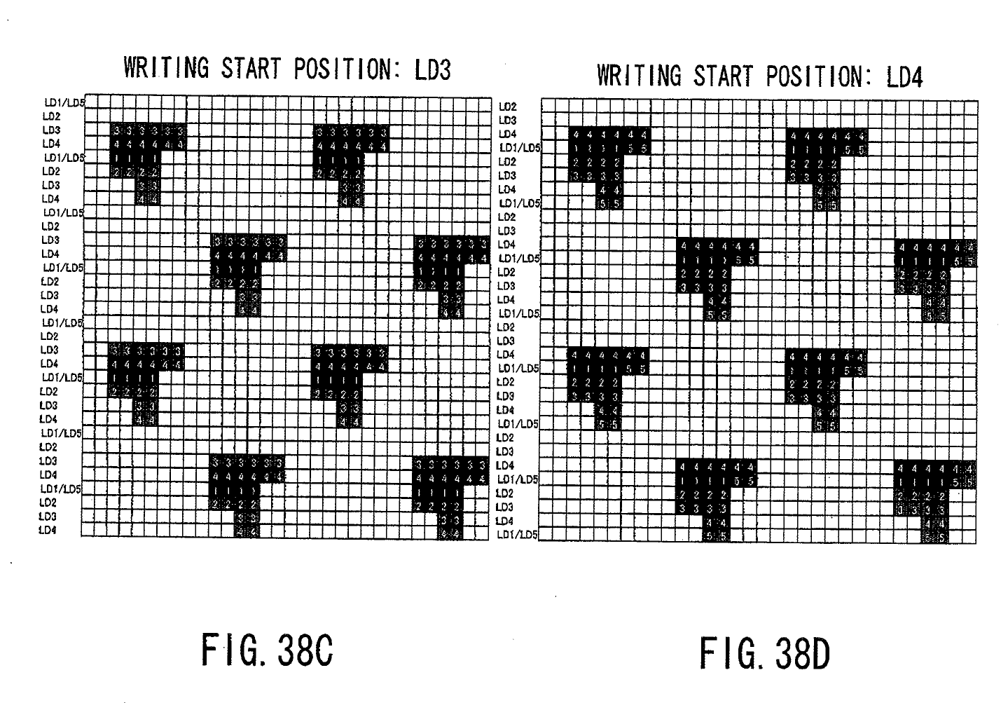

FIGS. 38A to 38D show the results of the equalization using four main exposure devices LD1 to LD4 and one redundant exposure device LD5. In more detail, a region having a dot width of 4 (sub scanning direction) of the element pattern is subjected to a process shown in FIG. 12B, a region having a dot width of 6 thereof is subjected to a process shown in FIG. 14B, and a region having a dot width of 2 thereof is subjected to a process shown in FIG. 10B.

As a result, as shown in FIGS. 38A to 38D, the number of reciprocity law failures which occur in the element pattern is equalized to four regardless of the writing start position of the element pattern and a halftone pattern having a uniform density can be obtained.

Since the reciprocity law failure which occurs in the main scanning direction cannot be equalized by the above-described method, a slight density variation may remain. In this case, the exposure energy control (the control of the peak laser power or the laser pulse width) described in the second embodiment may be performed. Accordingly, it is possible to further decrease the influence of the reciprocity law failure.

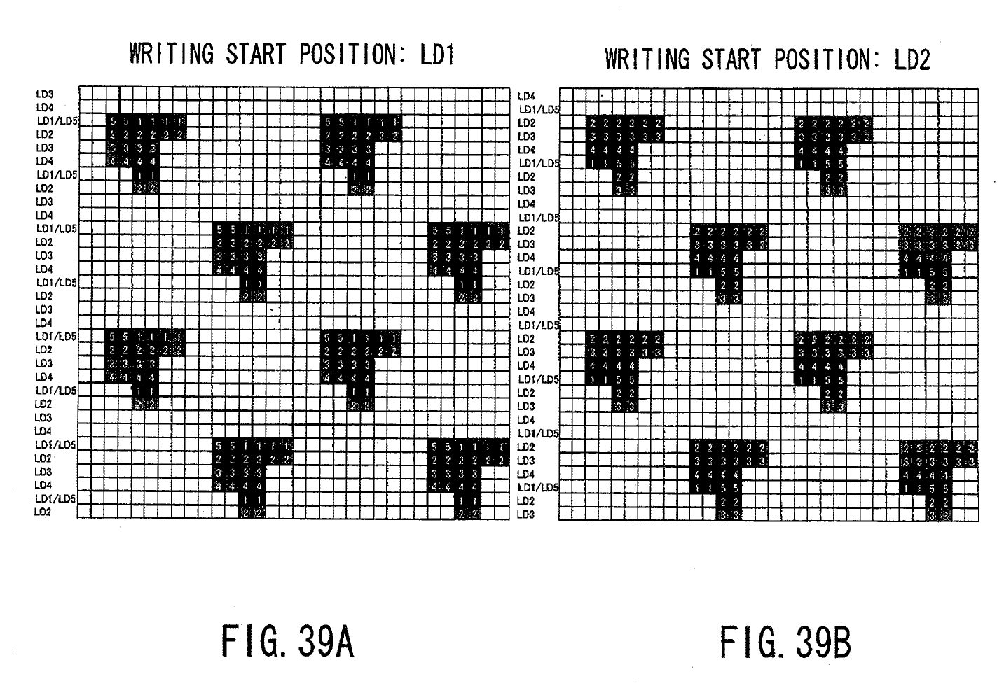

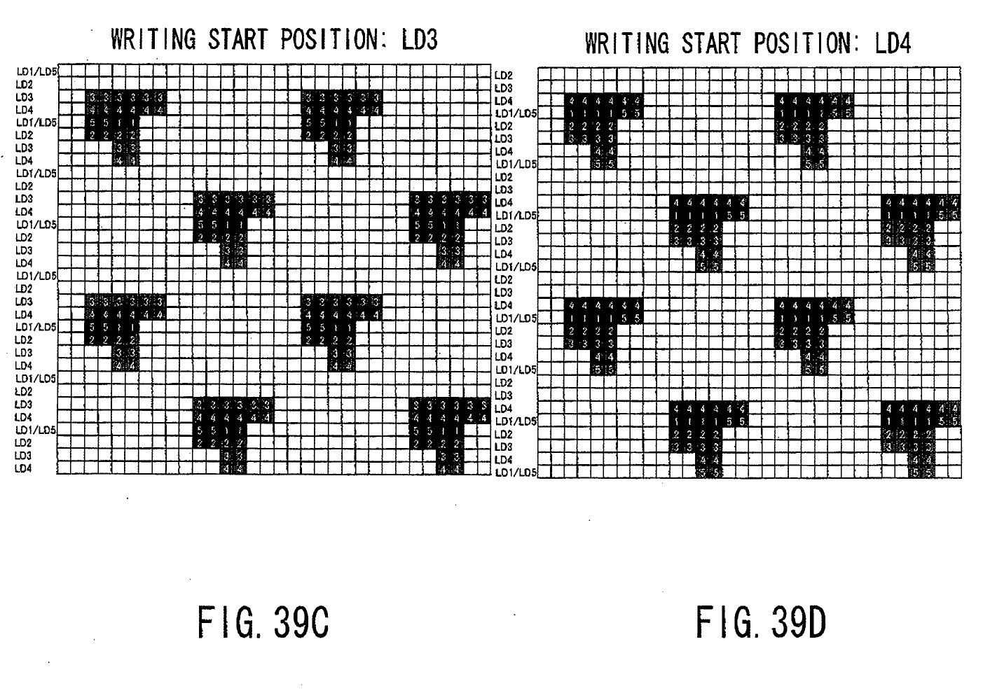

The shape of the element pattern is two-dimensionally determined and the occurrence number of reciprocity law failures in the element pattern in the sub scanning direction and the main scanning direction may be equalized regardless of the writing start position. FIGS. 39A to 39D are views showing the two-dimensional arrangement of the main exposure devices LD1 to LD4 and the redundant exposure device LD5 obtained on the basis of the two-dimensional determining method. In FIGS. 39A to 39D, the occurrence number of reciprocity law failures in the element pattern is equalized to four in the sub scanning direction and one in the main scanning direction regardless of the writing start position. As a result, a halftone pattern having a uniform density can be obtained without controlling the peak laser power or the laser pulse width.

As described above, according to the image forming apparatus 1, the beam scanning apparatus 30, and the beam scanning method of the present embodiment, it is possible to decrease the influence of the reciprocity law failure regardless of the width or the shape of the formed image or the writing start position of the image without deteriorating the use efficiency of the light source and obtain an image having a uniform density.

The present invention is not limited to the above-described embodiments and may be modified without departing from the scope of the present invention. Various embodiments may be embodied by proper combinations of the plurality of components disclosed in the above-described embodiments. For example, several components may be omitted from the above-described embodiments. The components of the different embodiments may be properly combined.

What is claimed is:

1. An image forming apparatus comprising:
a photoconductor;
a light source configured to include a plurality of main exposure devices and a plurality of redundant exposure devices;
a beam scanning unit configured to arrange a plurality of main laser beam spots output from the main exposure devices in a sub scanning direction of the photoconductor such that the main laser beam spots are separated from one another by an image-forming unit distance, arrange a plurality redundant laser beam spots output from the redundant exposure devices in the sub scanning direction of the photoconductor such that the redundant laser beam spots are separated from one another by the image-forming unit distance subsequently to the main laser beam spots, and simultaneously scan the main laser beam spots and the redundant laser beam spots in the main scanning direction of the photoconductor; and
a device selection unit configured to select exposure devices used in one-time scanning of the main scanning direction from the plurality of main exposure devices and the plurality of redundant exposure devices,
wherein, when an image which are continuous in the sub scanning direction are exposed, the device selection unit selects the exposure devices such that the number of pairs of pixels which are adjacent and are exposed by different scannings is equalized in the sub scanning direction of the image without depending on writing start positions of the image in the sub scanning direction.

2. The apparatus according to claim 1, wherein:
the beam scanning unit arranges the positions of the plurality of redundant laser beam spots in a scanning and a portion of the positions of the plurality of main laser beam spots in the next scanning so as to overlap with each other in the sub scanning direction, and
the device selection unit selects the exposure devices such that any one of the redundant laser beam spots and the main laser beam spots arranged so as to overlap with each other in the sub scanning direction is selected at the same position.

3. The apparatus according to claim 2, wherein for the case in which if only the main exposure devices are selected to expose the image, two-time scanning is required to expose more than two pixels adjacent in the sub scanning direction, the device selection unit selects the exposure devices such that the more than two pixels are exposed by one-time scanning.

4. The apparatus according to claim 2, wherein for the case in which if only the main exposure devices are selected to expose the image, one-time scanning is sufficient to expose more than two pixels adjacent in the sub scanning direction, the device selection unit selects the exposure devices such that the more than two pixels are exposed by two-time scanning.

5. The apparatus according to claim 2, wherein, when the number of main exposure devices is n (n is a natural number of 2 or more) and the number of redundant exposure devices is m (m is a natural number of 1 or more), a minimum value of m is a minimum integer satisfying
m≧(n−1)/2, and
wherein, a distance in the sub scanning direction between laser beam spots adjacent to each other on the photoconductor is p, and a moving amount in the sub scanning direction on the photoconductor during a time for one scanning in the main scanning direction is n·p.

6. The apparatus according to claim 2, wherein, when the number of main exposure devices is n (n is a natural number of 2 or more), the number of redundant exposure devices is m (m is a natural number of 1 or more), and the total number of main exposure devices and the redundant exposure devices is k (k=n+m), a minimum value of m is a minimum integer satisfying
m≧(k−1)/3, and
wherein, a distance in the sub scanning direction between laser beam spots adjacent to each other on the photoconductor is p, and a moving amount in the sub scanning direction on the photoconductor during a time for one scanning in the main scanning direction is n·p.

7. The apparatus according to claim 2, wherein, when the width of the image in the sub scanning direction is N pixels (N is an even number of 2 or more), the number of main exposure devices is n (n is a positive multiple of 4) and the number of redundant exposure devices is m (m is a natural number of 1 or more), a minimum value of m is
m=(n/2)−1, and
wherein, a distance in the sub scanning direction between laser beam spots adjacent to each other on the photoconductor is p, and a moving amount in the sub scanning direction on the photoconductor during a time for one scanning in the main scanning direction is n·p.

8. The apparatus according to claim 2, wherein, when the width of the image in the sub scanning direction is N pixels (N is an even number of 2 or more), the number of main exposure devices is n (n is a positive multiple of 4), the number of redundant exposure devices is m (m is a natural number of 1 or more) and the total number of main exposure devices and the redundant exposure devices is k (k=n+m), a minimum value of k is
k=(3n/2)−1, and
wherein, a distance in the sub scanning direction between laser beam spots adjacent to each other on the photoconductor is p, and a moving amount in the sub scanning direction on the photoconductor during a time for one scanning in the main scanning direction is n·p.

9. The apparatus according to claim 2, wherein the device selection unit selects the exposure device such that, by decreasing the number of pairs of pixels which are adjacent and are exposed by different scannings, the number of pairs of pixels is equalized in the sub scanning direction of the image without depending on the writing start position of the image in the sub scanning direction.

10. The apparatus according to claim 9, wherein, when the number of main exposure devices is n (n is a natural number of 2 or more) and the number of redundant exposure devices is m (m is a natural number of 1 or more), a minimum value of m is
m=n−1, and
wherein, a distance in the sub scanning direction between laser beam spots adjacent to each other on the photoconductor is p, and a moving amount in the sub scanning direction on the photoconductor during a time for one scanning in the main scanning direction is n·p.

11. The apparatus according to claim 2, wherein the device selection unit selects the exposure device such that, by increasing the number of pairs of pixels which are adjacent and are exposed by different scannings and, the number of pairs of pixels is equalized in the sub scanning direction of the image without depending on the writing start position of the image in the sub scanning direction.

12. The apparatus according to claim 11, wherein, when the number of main exposure devices is n (n is a natural number of 2 or more) and the number of redundant exposure devices is m (m is a natural number of 1 or more), a minimum value of m is
m=n−1, and
wherein, a distance in the sub scanning direction between laser beam spots adjacent to each other on the photoconductor is p, and a moving amount in the sub scanning direction on the photoconductor during a time for one scanning in the main scanning direction is n·p.

13. The apparatus according to claim 1, further comprising a power control unit configured to control laser power of the main exposure devices and the redundant exposure devices,
wherein the power control unit decreases the laser power of any one of the main exposure devices and the redundant exposure devices corresponding to the adjacent pixels to be lower than that of the other region if the pixel of the main laser beam and the pixel of the redundant laser beam are adjacent on the same line in the main scanning direction when the image is exposed.

14. The apparatus according to claim 1, further comprising a pulse width control unit configured to control laser pulse width of the main exposure devices and the redundant exposure devices,
wherein the pulse width control unit decreases the laser pulse width of any one of the main exposure devices and the redundant exposure devices corresponding to the adjacent pixels to be narrower than that of the other region if the pixel of the main laser beam and the pixel of the redundant laser beam are adjacent on the same line in the main scanning direction when the image is exposed.

15. The apparatus according to claim 1, wherein, when a halftone pattern including a plurality of element patterns, the element patterns being continuous in the sub scanning direction, is exposed, the device selection unit selects the exposure device such that the number of pairs of pixels which are adjacent and are exposed by different scannings is equalized in the sub scanning direction of the image without depending on the writing start position of the image in the sub scanning direction.

16. A beam scanning apparatus comprising:
a light source configured to include a plurality of main exposure devices and a plurality of redundant exposure devices;
a beam scanning unit configured to arrange a plurality of main laser beams output from the main exposure devices in a sub scanning direction of the photoconductor such that the main laser beams are separated from one another by an image-forming unit distance, arrange a plurality redundant laser beams output from the redundant exposure devices in the sub scanning direction of the photoconductor such that the redundant laser beams are separated from one another by the image-forming unit distance subsequently to the main laser beams, and simultaneously scan the main laser beams and the redundant laser beams in the main scanning direction of the photoconductor; and
a device selection unit configured to select exposure devices used in one-time scanning of the main scanning direction from the plurality of main exposure devices and the plurality of redundant exposure devices,
wherein, when an image which are continuous in the sub scanning direction are exposed, the device selection unit selects the exposure devices such that the number of pairs of pixels which are adjacent and are exposed by different scannings is equalized in the sub scanning direction of the image without depending on writing start positions of the image in the sub scanning direction.

17. The apparatus according to claim 16, wherein:
the beam scanning unit arranges the positions of the plurality of redundant laser beams in a scanning and a portion of the positions of the plurality of main laser beams in the next scanning so as to overlap with each other in the sub scanning direction, and
the device selection unit selects the exposure devices such that any one of the redundant laser beams and the main laser beams arranged so as to overlap with each other in the sub scanning direction is selected at the same position.

18. The apparatus according to claim 17, wherein, when the number of main exposure devices is n (n is a natural number of 2 or more) and the number of redundant exposure devices is m (m is a natural number of 1 or more), a minimum value of m is a minimum integer satisfying
m≧(n−1)/2, and
wherein, a distance in the sub scanning direction between beam spots adjacent to each other on the photoconductor is p, and a moving amount in the sub scanning direction on the photoconductor during a time for one scanning in the main scanning direction is n·p.

19. A beam scanning method comprising:
arranging a plurality of main laser beam spots output from a plurality of main exposure devices in a sub scanning direction of a photoconductor such that the main laser beam spots are separated from one another by an image-forming unit distance;
arranging a plurality of redundant laser beam spots output from a plurality of redundant exposure devices in the sub scanning direction of the photoconductor subsequently to the arrangement of the main laser beam spots such that the redundant laser beam spots are separated from one another by an image-forming unit distance;
simultaneously scanning the main laser beam spots and the redundant laser beam spots in a main scanning direction of the photoconductor; and
selecting exposure devices used in one-time scanning of the main scanning direction from the plurality of main exposure devices and the plurality of redundant exposure devices,
wherein, when an image which are continuous in the sub scanning direction are exposed, the selecting includes selecting the exposure devices such that the number of pairs of pixels which are adjacent and are exposed by different scannings is equalized in the sub scanning direction of the image without depending on writing start positions of the image in the sub scanning direction.

20. The method according to claim 19, wherein:
the arranging of the main laser beam spots and the arranging of the redundant laser beam spots include arranging the positions of the plurality of redundant laser beam spots in a scanning and a portion of the positions of the plurality of main laser beam spots in the next scanning so as to overlap with each other in the sub scanning direction, and
the selecting includes selecting the exposure device such that any one of the redundant laser beam spots and the main laser beam spots arranged so as to overlap with each other in the sub scanning direction is selected at the same position.

21. The method according to claim 20, wherein, when the number of main exposure devices is n (n is a natural number of 2 or more) and the number of redundant exposure devices is m (m is a natural number of 1 or more), a minimum value of m is a minimum integer satisfying
m≧(n−1)/2, and
wherein, a distance in the sub scanning direction between laser beam spots adjacent to each other on the photoconductor is p, and a moving amount in the sub scanning direction on the photoconductor during a time for one scanning in the main scanning direction is n·p.
